(19) United States
(12) Patent Application Publication
(10) Pub. No.: US 2023/0056173 A1
(43) Pub. Date: Feb. 23, 2023

(54) REAL-TIME PROVISIONING OF TARGETED DIGITAL CONTENT ASSOCIATED WITH FUTURE DATA EXCHANGES BASED ON STRUCTURED MESSAGING DATA

(71) Applicant: The Toronto-Dominion Bank, Toronto (CA)

(72) Inventors: Christopher Mark JONES, Villanova, PA (US); Barry Wayne Baird, JR., Kennett Square, PA (US); Claude Bernell Lawrence, JR., Philadelphia, PA (US); Jonathan Joseph Prendergast, West Chester, PA (US)

(21) Appl. No.: 17/889,234

(22) Filed: Aug. 16, 2022

Related U.S. Application Data
(60) Provisional application No. 63/234,125, filed on Aug. 17, 2021.

(51) Int. Cl. G06Q 20/32; G06Q 20/42

(52) U.S. Cl. CPC G06Q 20/3255; G06Q 20/42

(57) ABSTRACT

The disclosed embodiments include computer-implemented systems and processes that generate and provision, in real-time, targeted digital content associated with future data exchanges based on structured messaging data. For example, an apparatus may receive a message associated with a real-time payment requested from a first counterparty by a second counterparty during a first temporal interval. The message includes elements of message data characterizing data exchange involving the first and second counterparties during a second temporal interval disposed subsequent to the first temporal interval, and based on the elements of messaging data, the apparatus may transmit digital content associated with the requested real-time payment and the data exchange to a device operable by the first counterparty. Further, and based on response data generated by the device, the apparatus may transmitting confirmation data associated with the real-time payment to a computing system operable by the second counterparty.

### CROSS-REFERENCE TO RELATED APPLICATION

This application claims the benefit of priority to U.S. Provisional Patent Application No. 63/234,125, filed on Aug. 17, 2021, the entire disclosure of which is expressly incorporated herein by reference to its entirety.

### TECHNICAL FIELD

The disclosed embodiments relate to computer-implemented systems and processes that provision, in real-time, targeted digital content associated with future data exchanges based on structured messaging data.

### BACKGROUND

Today, the mass adoption of smart phones and digital payments within the global marketplace drives an increasingly rapid adoption of real-time payment (RTP) technologies by financial institutions, consumers, vendors and merchants, and other participants in the payment ecosystem. Many RTP technologies emphasize data, messaging, and global interoperability and in contrast to many payment rails, such as those that support credit card payments, embrace the near ubiquity of mobile technologies in daily life.

### SUMMARY

In some examples, an apparatus includes a communications interface, a memory storing instructions, and at least one processor coupled to the communications interface and to the memory, the at least one processor being configured to execute the instructions to receive, via the communications interface, a message associated with a real-time payment requested from a first counterparty by a second counterparty during a first temporal interval. The message includes elements of message data disposed within corresponding message fields, and the elements of message data characterize an exchange of data involving the first and second counterparties during a second temporal interval disposed subsequent to the first temporal interval. The at least one processor is further configured to execute the instructions to, based on the elements of messaging data, transmit notification data to a device operable by the first counterparty via the communications interface. The notification data includes digital content associated with the requested real-time payment and the data exchange, and the device is configured to present the digital content within a digital interface. The at least one processor is further configured to execute the instructions to, based on response data generated by the device, transmit first confirmation data associated with the real-time payment to a computing system operable by the second counterparty via the communications interface. The computing system is configured to initiate the data exchange during the second temporal interval based on the first confirmation data.

In other examples, a computer-implemented method includes receiving, using at least one processor, a message associated with a real-time payment requested from a first counterparty by a second counterparty during a first temporal interval. The message includes elements of message data disposed within corresponding message fields, and the elements of message data characterize an exchange of data involving the first and second counterparties during a second temporal interval disposed subsequent to the first temporal interval. The computer-implemented method also includes, based on the elements of messaging data, transmitting, using the at least one processor, notification data to a device operable by the first counterparty, the notification data comprising digital content associated with the requested real-time payment and the data exchange. The device is configured to present the digital content within a digital interface. The computer-implemented method also includes, based on response data generated by the device, transmitting, using the at least one processor, first confirmation data associated with the real-time payment to a computing system operable by the second counterparty. The computing system is configured to initiate the data exchange during the second temporal interval based on the first confirmation data.

Further, in some examples, a tangible, non-transitory computer-readable medium stores instructions that, when executed by at least one processor, cause the at least one processor to perform a method that includes receiving a message associated with a real-time payment requested from a first counterparty by a second counterparty during a first temporal interval. The message includes elements of message data disposed within corresponding message fields, and the elements of message data characterize an exchange of data involving the first and second counterparties during a second temporal interval disposed subsequent to the first temporal interval. The method also includes, based on the elements of messaging data, transmitting notification data to a device operable by the first counterparty. The notification data includes digital content associated with the requested real-time payment and the data exchange, and the device is configured to present the digital content within a digital interface. The method also includes, based on response data generated by the device, transmitting first confirmation data associated with the real-time payment to a computing system operable by the second counterparty. The computing system is configured to initiate the data exchange during the second temporal interval based on the first confirmation data.

It is to be understood that both the foregoing general description and the following detailed description are exemplary and explanatory only and are not restrictive of the invention, as claimed. Further, the accompanying drawings, which are incorporated in and constitute a part of this specification, illustrate aspects of the present disclosure and together with the description, serve to explain principles of the disclosed embodiments as set forth in the accompanying claims.

### BRIEF DESCRIPTION OF THE DRAWINGS

FIG. 1 is a block diagram of an exemplary computing environment, in accordance with some exemplary embodiments.

FIG. 2A is a block diagram illustrating a portion of an exemplary computing environment, in accordance with some exemplary embodiments.

FIG. 2B illustrates portions of an exemplary request for payment (RFP), in accordance with some exemplary embodiments.

FIGS. 3A, 3B, and 3C are block diagrams illustrating portions of an exemplary computing environment, in accordance with some exemplary embodiments.

FIGS. 4A, 4B, and 4C are flowcharts of exemplary processes for provisioning, in real-time, targeted digital associated with future data exchanges to customer devices based on structured messaging data, in accordance with some exemplary embodiments.

Like reference numbers and designations in the various drawings indicate like elements.

### DETAILED DESCRIPTION

Today, the mass adoption of smart phones and digital payments within the global marketplace drives an adoption of real-time payment (RTP) technologies by financial institutions, consumers, vendors and merchants, and other participants in the payment ecosystem. These RTP technologies often emphasize data, messaging, and global interoperability and in contrast to conventional payment rails, may embrace the near ubiquity of mobile technologies in daily life to provide, to the participants in the RTP ecosystem, real-time service and access to funds. To facilitate the strong emphasis on data, messaging, and global interoperability between financial institutions, many RTP technologies adopt, and exchange data formatted in accordance with, one or more standardized data-exchange protocols, such as the ISO 20022 standard for electronic data exchange between financial institutions.

Further, many participants in the RTP system, such as merchants that adopt RTP technologies, experience temporal fluctuations in business activity due to factors such as seasonality, weather, or market conditions. These temporal fluctuations in business activity often impact an ability of these participants in the RTP ecosystem to forecast revenue or cash flow during future temporal intervals, which leads to uncertainty in staffing, inventory, and procurement decisions during these future temporal intervals. In some instances, and to address these temporal fluctuations in business activity, a merchant may elect to offer an existing or potential customer an ability to initiate a future purchase transaction in accordance with one or more predetermined, and fixed, terms and conditions based on an approval of an initial down payment of an agreed-upon amount (e.g., a “down payment”), which the merchant may request during a current temporal interval.

In some examples, and to accept the merchant's offer to initiate the future purchase transaction in accordance with the one or more predetermined, and fixed, terms and conditions, the existing or prospective customer may initiate a transaction that funds the initial, down payment using a corresponding payment instrument held by the customer, either through in-person interaction at a physical location of the merchant, or through digital interactions with a computing system of the merchant (e.g., via a web page or other digital portal). The merchant computing system may perform operations that generate elements of messaging data identifying and characterizing the merchant and the initiated transaction, and including data characterizing the payment instrument and the agreed-upon amount of the initial down payment, and that submit the generated elements of messaging data to a transaction processing network or payment rail in accordance with a predetermined schedule, e.g., in batch form with other elements of messaging data at a predetermined time on a daily basis. In some instances, one or more computing systems of the transaction processing network or payment rail may perform operations that execute, clear, and settle the initiated transaction involving the payment instrument within a predetermined temporal interval subsequent to the initiation of the transaction, such as, but not limited to, forty-eight hours.

In other examples, the merchant computing system (or a computing system associated with a financial institution of the merchant) may generate a message, e.g., a Request for Payment (RFP) message, that requests, in real-time, the agreed-upon amount of the initial down payment from the customer, and the customer's approval of the real-time payment in the agreed-upon amount may “lock-down” the customer's ability to initiate the purchase transaction during the future temporal interval in accordance with the predetermined, and fixed, terms and conditions. The merchant computing system (or a computing system associated with a financial institution of the merchant) may transmit the RFP message to a computing system of the financial institution of the customer, e.g., directly or through one or more intermediate systems associated with the RTP ecosystem, such as a clearinghouse system.

The generated and transmitted RFP message may, for example, be formatted in accordance with the ISO 20022 data-exchange format, and may include message fields populated with information that includes, but is not limited to, information identifying the customer and the merchant, information characterizing the requested, real-time payment (e.g., the agreed-upon amount of the initial down payment, a requested payment date, an identifier of an payment instrument held by the customer and available to fund the requested, real-time payment, or an identifier of an account of the merchant capable of receiving proceeds from the requested, real-time payment, etc.), and information characterizing the offer to initiate the purchase transaction during the future temporal interval and in accordance with the predetermined, and fixed, terms and conditions. Further, the ISO-20022-compliant RFP message may also include a link within a structured or unstructured message field to information, such as offer data, associated with the requested, real-time payment and the offered ability to initiate the purchase transaction during the future temporal interval and in accordance with the predetermined, and fixed, terms and conditions (e.g., a long- or shortened Uniform Resource Location (URL) pointing to a formatted offer data that includes any of the information described herein).

Further, the computing system of the customer's financial institution (e.g., “FI computing system”) may perform any of the exemplary processes described herein to obtain, receive, or intercept the RFP message that characterizes the initial, real-time payment requested from the customer to reserve the customer's ability to initiate the purchase transaction involving the merchant during the future temporal interval in accordance with the predetermined, and fixed, terms and conditions. Based on elements of mapping data that characterize a structure, composition, or format of one or more data fields of the ISO-20022-compliant RFP message, the FI computing system may perform any of the exemplary processes described herein to decompose the received RFP message and obtain elements of decomposed field data characterizing the customer, the merchant, the initial, real-time payment requested from user 101 by merchant 111, and additionally, or alternatively, the predetermined terms and conditions of the future purchase transaction.

Further, the FI computing system may also provision payment and offer notifications characterizing the initial, real-time payment requested from the customer (e.g., the agreed-upon amount of the down payment, etc.), and the predetermined terms and conditions of the future purchase transaction “locked down” by the initial, real-time payment to a device operable by the customer, and an application program executed by the customer device may perform operations, described herein, that render the product notification for presentation with a portion of a digital interface. Upon presentation within the digital interface of the customer device, the payment and offer notification may, among other things, identify and characterize the opportunity, offered to the customer, to reserve the ability to initiate the purchase transaction involving the merchant during the future temporal interval in accordance with the predetermined, and fixed, terms and conditions, and may prompt the customer to accept the offered opportunity by provisioning customer data that approves the real-time payment requested from the customer in the agreed-upon amount of the down payment.

Further, and based on confirmation data indicative of the customer's acceptance of the offered opportunity, and the customer's approval of the requested, real-time payment, the FI computing system may perform any of the exemplary processes described herein to execute the requested, real-time payment in accordance with the decomposed field data, and generate an additional, ISO-2002-compliant RTP message that, when provisioned to the merchant computing system (or to the intermediate computing system, such as the computing system of the merchant's financial institution), confirms the successful execution of the requested down payment and the reservation of the customer's ability to initiate the purchase transaction involving the merchant during the future temporal interval in accordance with the predetermined, and fixed, terms and conditions, e.g., in real-time and contemporaneously with the generation of the corresponding RFP message by the merchant computing system.

Certain of the exemplary processes described herein, which decompose the structured message fields of an ISO-20022-compliant RFP message to obtain elements of decomposed message data characterizing the customer, the merchant, the offered opportunity to initiate the purchase transaction involving the merchant during the future temporal interval in accordance with the predetermined, and fixed, terms and conditions, and the requested, real-time payment associated with the offered opportunity, and which provision data characterizing the offered opportunity and the requested, real-time payment to the customer device for presentation within a digital interface in real-time and contemporaneously with the generation of the corresponding RFP message by the merchant computing system, may be implemented in addition to, or as an alternate to, many processes that relay on the often-limited content of temporally delayed message data transmitted across many existing payment rails and transaction processing networks.

### A. Exemplary Computing Environments

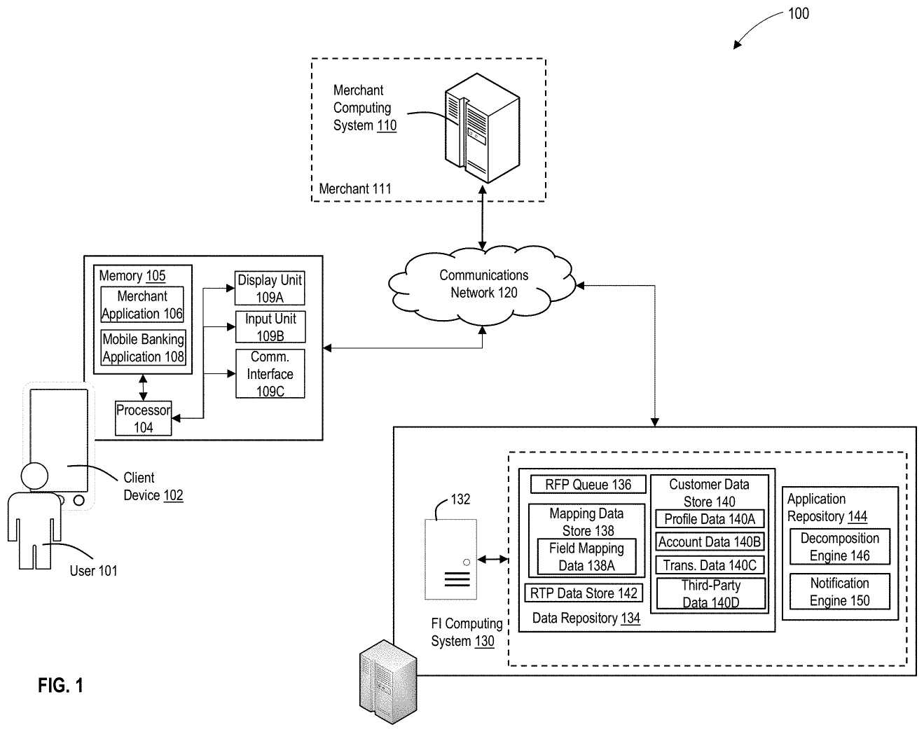

FIG. 1 is a diagram illustrating an exemplary computing environment 100 that includes, among other things, one or more computing devices, such as a client device 102, and one or more computing systems, such as a merchant computing system 110 and a financial institution (FI) computing system 130, each of which may be operatively connected to, and interconnected across, one or more communications networks, such as communications network 120. Examples of communications network 120 include, but are not limited to, a wireless local area network (LAN), e.g., a “Wi-Fi” network, a network utilizing radio-frequency (RF) communication protocols, a Near Field Communication (NFC) network, a wireless Metropolitan Area Network (MAN) connecting multiple wireless LANs, and a wide area network (WAN), e.g., the Internet.

Client device 102 may include a computing device having one or more tangible, non-transitory memories, such as memory 105, that store data and/or software instructions, and one or more processors, e.g., processor 104, configured to execute the software instructions. The one or more tangible, non-transitory memories may, in some aspects, store application programs, application engines or modules, and other elements of code executable by the one or more processors, such as, but not limited to, an executable web browser (e.g., Google Chrome™, Apple Safari™, etc.), an executable application associated with merchant computing system 110 (e.g., merchant application 106), and additionally or alternatively, an executable application associated with FI computing system 130 (e.g., mobile banking application 108).

Client device 102 may also include a display unit 109A configured to present interface elements to a corresponding user or customer, such as a user 101, and an input unit 109B configured to receive input from user 101, e.g., in response to the interface elements presented through display unit 109A. By way of example, display unit 109A may include, but is not limited to, an LCD display unit or other appropriate type of display unit, and input unit 109B may include, but is not limited to, a keypad, keyboard, touchscreen, voice activated control technologies, or appropriate type of input unit. Further, in additional aspects (not illustrated in FIG. 1), the functionalities of display unit 109A and input unit 109B may be combined into a single device, e.g., a pressure-sensitive touchscreen display unit that presents interface elements and receives input from user 101. Client device 102 may also include a communications interface 109C, such as a wireless transceiver device, coupled to processor 104 and configured by processor 104 to establish and maintain communications with communications network 120 via one or more communication protocols, such as WiFi®, Bluetooth®, NFC, a cellular communications protocol (e.g., LTE®, CDMA®, GSM®, etc.), or any other suitable communications protocol.

Examples of client device 102 may include, but not limited to, a personal computer, a laptop computer, a tablet computer, a notebook computer, a hand-held computer, a personal digital assistant, a portable navigation device, a mobile phone, a smart phone, a wearable computing device (e.g., a smart watch, a wearable activity monitor, wearable smart jewelry, and glasses and other optical devices that include optical head-mounted displays (OHMDs)), an embedded computing device (e.g., in communication with a smart textile or electronic fabric), and any other type of computing device that may be configured to store data and software instructions, execute software instructions to perform operations, and/or display information on an interface device or unit, such as display unit 109A. In some instances, client device 102 may also establish communications with one or more additional computing systems or devices operating within computing environment 100 across a wired or wireless communications channel, e.g., via the communications interface 109C using any appropriate communications protocol. Further, user 101 may operate client device 102 and may do so to cause client device 102 to perform one or more exemplary processes described herein.

Each of merchant computing system 110 and FI computing system 130 may represent a computing system that includes one or more servers and one or more tangible, non-transitory memory devices storing executable code, application engines, or application modules. Further, each of the one or more servers may include one or more processors, which may be configured to execute portions of the stored code, application engines, or application modules to perform operations consistent with the disclosed exemplary embodiments. For example, as illustrated in FIG. 1, the one or more servers of FI computing system 130 may include server 132 having one or more processors configured to execute portions of the stored code, application engines, or application modules maintained within the one or more corresponding, tangible, non-transitory memories. In some instances, merchant computing system 110 and/or FI computing system 130 may correspond to a discrete computing system, although in other instances, one or more of merchant computing system 110 or FI computing system 130 may correspond to a distributed computing system having multiple, computing components distributed across an appropriate computing network, such as communications network 120, or those established and maintained by one or more cloud-based providers, such as Microsoft Azure™, Amazon Web Services™, or another third-party, cloud-services provider. Further, merchant computing system 110 and FI computing system 130 may also include one or more communications units, devices, or interfaces, such as one or more transceiver devices, coupled to the one or more processors for accommodating wired or wireless internet communication across network 120 with other computing systems and devices operating within environment 100 (not illustrated in FIG. 1).

Merchant computing system 110 may be associated with, or operated by, a corresponding merchant 111 that offers products or services for sale to one or more customers, such as, but not limited to, user 101 that operates client device 102. Further, and as described herein, FI computing system 130 may be associated with, or operated by, a financial institution that offers financial products or services to one or more customers, such as, but not limited to, user 101. The financial products or services may, for example, include a financial product issued to user 101 by the financial institution and available to fund purchase transactions initiated by user 101 and involving merchant 111, and examples of the payment instrument may include, but are not limited to, a credit card account issued by the financial institution, a secured or unsecured credit product issued by the financial institution (e.g., an unsecured or secured line-of-credit, an unsecured personal loan, etc.), or a checking, savings, or other deposit account issued by and maintained at the financial institution.

In some instances, and to address temporal fluctuations in business activity due to factors such as seasonality, weather, or market conditions, merchant 111 may elect to offer an existing or potential customer an ability to initiate a future purchase transaction involving merchant 111 in accordance with one or more predetermined, and fixed, terms and conditions based on an approval of an initial, real-time payment in an agreed-upon amount (e.g., a “down payment”), which merchant 111 may request from user 101 during a current temporal interval. Merchant computing system 110 (or an additional computing system associated with merchant 111, such as a computing system operated by a financial institution of merchant 111) may perform operations, described herein, to generate a request-for-payment (RFP) message associated with the initial, real-time payment requested from user 101 by merchant 111, an approval of which may “lock-down” an ability of user 101 to initiate the purchase transaction during a future temporal interval and in accordance with the predetermined, and fixed, terms and conditions, and to broadcast the RFP message across network 120 to FI computing system 130, either directly or through one or more intermediate computing systems associated with the RFP ecosystem, such as a computing system of a clearinghouse system.

Further, FI computing system 130 may perform any of the exemplary processes described herein to obtain, receive, or intercept the RFP message that characterizes the initial, real-time payment requested from user 101 (e.g., a first counterparty) by merchant 111 (e.g., a corresponding second counterparty) to reserve the ability of user 101 to initiate the purchase transaction involving merchant 111 during the future temporal interval in accordance with the predetermined terms, and fixed, and conditions. As described herein, the received RFP message may be formatted and structured in accordance with one or more standardized data-exchange protocols, such as the ISO 20022 standard for electronic data exchange between financial institutions. Further, and based on elements of mapping data that characterize a structure, composition, or format of one or more data fields of the ISO-20022-compliant RFP message, FI computing system 130 may perform any of the exemplary processes described herein to decompose the received RFP message and obtain data characterizing user 101, merchant 111 associated with merchant computing system 110, the initial, real-time payment requested from user 101 by merchant 111, and additionally, or alternatively, the predetermined terms and conditions of the future purchase transaction.

For example, the obtained data (e.g., “decomposed field” data) may include one or more of: (i) customer data identifying user 101, such as a unique customer identifier (e.g., a customer name, an alphanumeric login credential, etc.) and a postal address; (ii) payment data characterizing the initial real-time payment requested from user 101 by merchant 111, such as an initial payment amount (e.g., the down payment on the future purchase transaction), a requested payment date or time, and an identifier of a customer account (e.g., from which the initial payment amount will be debited) and a merchant account (e.g., to which the initial payment amount will be credited); (iii) counterparty data identifying merchant 111, such as a counterparty name (e.g., a merchant name, etc.) and postal address; and (iv) transaction data that identifies a value of one or more parameters of the future purchase transactions, including values of the predetermined terms and conditions described herein (e.g., a transaction amount, an identifier of one or more of the products or services involved in the future purchase transactions, a duration of the future temporal interval, etc.).

Further, FI computing system 130 may perform operations that generate respective payment and offer notifications (e.g., consistent with the ISO 20022 data-exchange protocol) characterizing the initial, real-time payment requested from user 101 by merchant 111, and the predetermined terms and conditions of the future purchase transaction “locked down” by the initial, real-time payment, and provision the payment notification to a device operable by user 101, such as client device 102. As described herein, client device 102 may perform operations that process the provisioned offer notification and present, via display unit 109A, one or more interface elements that identify the initial, real-time payment requested from user 101 by merchant 111, and the predetermined terms and conditions of the future purchase transaction “locked down” by the initial, real-time payment, and that prompt user 101 to accept, or alternatively, reject, the pre-approved loan product. In some instances, and based on the approval of the initial, real-time payment, FI computing system 130 may perform any of the exemplary processes described herein to execute the initial, real-time payment and that provision, to merchant computing system 110, data confirming the execution of the initial, real-time payment to merchant computing system 110, which may perform operations that maintain, within the one or more tangible, non-transitory memories, data characterizing the reservation, by user 101, of the ability to initiate the purchase transaction during the future temporal interval in accordance with the predetermined, and fixed, terms and conditions.

To facilitate a performance of one or more of these exemplary processes, FI computing system 130 may maintain, within the one or more tangible, non-transitory memories, a data repository 134 that includes, but is not limited to, a request-for-payment (RFP) queue 136, a mapping data store 138, a customer data store 140, and a real-time payment (RTP) data store 142. RFP queue 136 may include one or more discrete RFP messages received by FI computing system 130 using any of the exemplary processes described herein. In some instances, the RFP messages maintained within RFP queue 136 may be prioritized in accordance with a time or date of receipt by FI computing system 130 or with requested payment data associated with each of the RFP messages, and each of the prioritized RFP messages may be associated with a corresponding temporal pendency. Further, FI computing system 130 may perform any of the exemplary processes described herein to provision elements of notification data associated with each of the RFP messages to a computing system or device associated with a corresponding customer (e.g., client device 102 associated with user 101), and FI computing system 130 may perform operations that maintain each of the RFP messages within RFP queue 136 until a receipt, at FI computing system 130, of confirmation data from corresponding ones of the computing systems or devices indicating an approval, or a rejection, of the corresponding requested payment, or until an expiration of the corresponding pendency period.

Mapping data store 138 may include structured or unstructured data records that maintain one or more elements of field mapping data 138A. For example, and as described herein, FI computing system 130 may receive, obtain, or intercept one or more RFP messages, each of which may be formatted and structured in accordance with a corresponding, standardized data-exchange protocol, such as the ISO 20022 standard for electronic data exchange between financial institutions. In some instances, the one or more elements of field mapping data 138A may characterize a structure, composition, or format of the message data populating one or more data fields of the ISO-20022-compliant RFP message, or a corresponding RFP message compliant with an additional, or alternate, standardized data-exchange protocol.

In some instances, customer data store 140 may include structured or unstructured data records that maintain information identifying and characterizing one or more customers of the financial institution, and further, interactions between these customers and not only the financial institution, but also other unrelated third parties, such as the merchants or retailers described herein. For example, as illustrated in FIG. 1, customer data store 140 may include one or more elements of profile data 140A, which identify and characterize corresponding ones of the customers of the financial institution, one or more elements of account data 140B, which may identify and characterize one or more accounts held by the customers, one or more elements of transaction data 140C, which identify and characterize prior purchase or payment transactions involving the customers of the financial institution (such as, but not limited to, user 101), and one or more elements of third-party data 140D associated with corresponding customers of the financial institution.

By way of example, for a corresponding one of the customers, such as user 101, the elements of profile data 140A may include, but are not limited to, a customer identifier of user 101 (e.g., an alphanumeric login credential, a customer name, etc.), a postal address of user 101, and values of one or more demographic parameters characterizing user 101 (e.g., a customer age, customer profession, etc.). The accounts held by the customers of the financial institution may include, but are not limited to, an account associated with a loan product (e.g., an installment loan, etc.), a deposit account (e.g., a checking or a savings account issued by the financial institution), a credit-card account, or an account associated with an additional, or alternate, financial product, such as an unsecured personal loan, and the elements of account data 140B may include, for an account held by a corresponding one of the customers, such as user 101, the customer identifier of user 101, all or a portion of an account number (e.g., an actual account number, a tokenized account number, etc.), and data characterizing a status of the account (e.g., a current balance, an overdue balance, length of account existence, etc.) and interactions between user 101 and the account (e.g., amounts and dates of withdrawals, etc.). Further, the elements of transaction data 140C may include the customer identifier of user 101, data identifying one or more prior purchase or payment transactions initiated by user 101 (e.g., a unique, alphanumeric transaction identifier assigned by FI computing system 130), and may include values of transaction parameters that characterize each of the prior purchase or payment transactions, such as a transaction data or time, a transaction amount, an identifier of a corresponding counterparty, or an identifier of an account (e.g., an account number, etc.) that funds, or receives proceeds from, the prior purchase or payment transaction.

The elements of third-party data 140D may, for a corresponding one of the customers, such as user 101, include the customer identifier of user 101 and one or more elements of governmental, judicial, regulatory, or reporting data associated with, and characterizing user 101. By way of example, the elements of third-party data 140D associated with user 101 may include one or more elements of data generated and maintained by a governmental entity (e.g., governmental data) that identifies parcels of real estate, vehicles, or other tangible properties held or owned by user 101. Additionally, or alternatively, the elements of third-party data 140D associated with user 101 may include one or more elements of data generated and maintained by a reporting entity, such as credit-bureau data that includes a credit score or data characterizing one or more credit inquiries associated with user 101 during corresponding temporal intervals. In some examples, FI computing system 130 perform operations that receive, via a secure programmatic channel of communications, one or more of the customer-specific elements of third-party data 140D maintained within customer data store 140 from one or more computing systems associated with corresponding governmental, judicial, regulatory, or reporting entities in accordance with a predetermined temporal schedule, on a continuous, streaming basis, or in response to a requested generated and transmitted by FI computing system 130.

RTP data store 142 may include one or more elements of decomposed field data generated through a decomposition of corresponding ones of the received RFP messages, e.g., based on the elements of field mapping data 138A and through an implementation of any of the exemplary processes described herein.

Further, and to facilitate the performance of any of the exemplary processes described herein, FI computing system 130 may also maintain, within the one or more tangible, non-transitory memories, an application repository 144 that maintains, among other things, a decomposition engine 146, and a notification engine 150, each of which may be executed by the one or more processors of FI computing system 130.

For example, and upon execution by the one or more processors of FI computing system 130, executed decomposition engine 146 may perform any of the exemplary processes described herein to obtain field mapping data 138A from mapping data store 138, to apply field mapping data 138A to a received, obtained, or intercepted RFP message, and based on the application of field mapping data 138A to the RFP message, to decompose the RFP message and obtain elements of message data that not only identify and characterize each counterparty involved in an initial purchase transaction (e.g., user 101 and merchant 111, as described herein), which reserves the ability of user 101 to initiate the purchase transaction involving merchant 111 during the future temporal interval in accordance with the predetermined terms and conditions, but also that identifies and characterizes the future purchase transaction, and the predetermined terms and conditions.

Upon execution by the one or more processors of FI computing system 130, notification engine 150 may perform any of the exemplary processes described herein to generate one or more elements of a payment notification that, when provisioned to client device 102 by FI computing system 130, cause one or more application programs executed by client device 102 to present interface elements within a corresponding digital interface that prompt user 101 to provide an approval, or rejection of the real-time payment requested from user 101 by merchant 111. As described herein, the approval of the requested, real-time payment by user 101 may reserve the ability of user 101 to initiate the purchase transaction at merchant 111 in accordance with the predetermined terms and conditions during the future temporal interval.

### B. Computer-Implemented Techniques for Performing Real-Time Reservation of a Future Data Exchanges Based on Structured Messaging Data

As described herein, to address temporal fluctuations in business activity due to factors such as seasonality, weather, or market conditions, a participant in the real-time payment (RTP) ecosystem, such as merchant 111, may elect to offer an existing or potential customer, such as user 101, an ability to initiate a future purchase transaction involving merchant 111 in accordance with one or more predetermined terms and conditions based on an approval of an initial, real-time payment of an agreed-upon amount (e.g., a “down payment”) requested by merchant 111 from user 101 during a current temporal interval. By way of example, merchant 111 may include a local home-improvement warehouse (e.g., “Lex's Home Improvement”) disposed proximate to a location of a home of user 101 within the Washington, D.C., area, and in an effort to address these temporal fluctuations in business activity, and to reduce corresponding uncertainties in future revenue streams and future expenditures on supplies and skilled labor, merchant 111 may elect to offer user 101 an opportunity to the reserve an ability to purchase a particular home-improvement service at a predetermined, and fixed, purchase price, such as a roof-replacement service in the amount of $12,000, during a future time interval, such as a future, six-month period, in accordance with one or more predetermined terms or conditions.

Further, as described herein, to reserve the ability of user 101 to complete the purchase of the roof-replacement services for $12,000.00 at any point during the future, six-month period, merchant 111 may request an immediate payment from user 101 of a predetermined portion of the fixed purchase price, such as, but not limited to, an agreed-upon payment amount of $1,000.00, e.g., as a down-payment on the fixed purchase price that “locks down” the predetermined terms and conditions of the future purchase transaction. In some instances, merchant computing system 110 may, either alone or in conjunction with additional, or alternative computing systems associated merchant 111 (e.g., a computing system operated by a financial institution of merchant 111) may perform any of the exemplary processes described herein to generate one or more messages having message fields structured in accordance with one or more standardized data-exchange protocols, such a request-for-payment (RFP) message having message fields may be populated with data structured and formatted in accordance with the ISO 20022 standard for data exchange between financial institutions, that identifies and characterizes the future purchase transaction, the future temporal interval, and the predetermined terms and conditions, and further, that requests from user 101 a real-time payment in the agreed-upon payment amount. Through a performance of these exemplary processes, merchant computing system 110 may perform operations, in conjunction with FI computing system 130, that enable user 101 to “lock-down” the predetermined terms and conditions of the future purchase transaction involving the roof-replacement services provided by merchant 111, and that provide merchant 111 with additional certainty regarding a revenue stream during the future, six-month temporal interval.

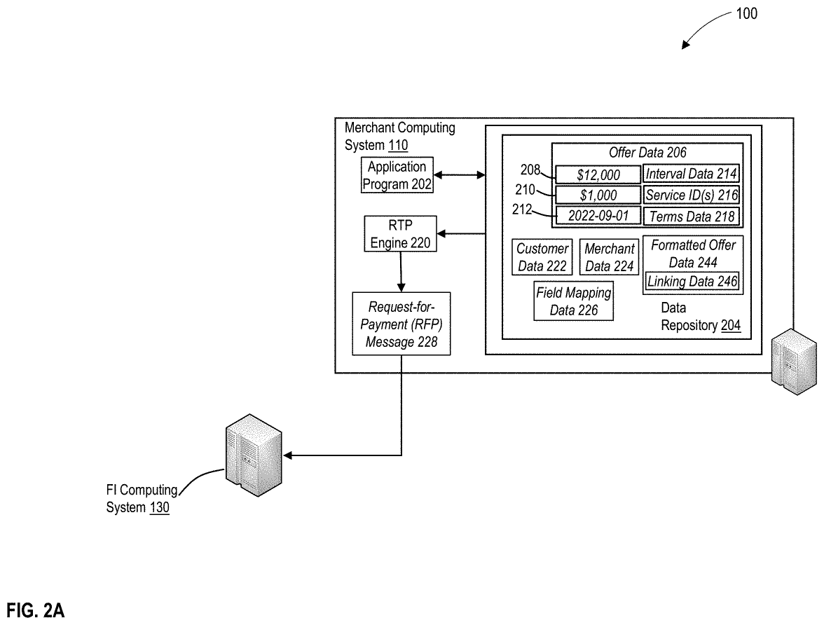

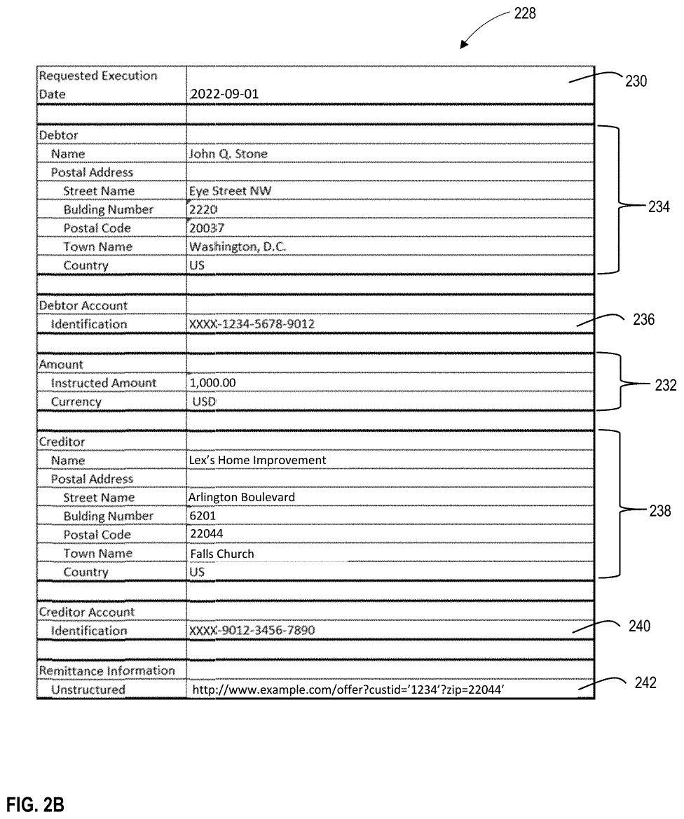

Referring to FIG. 2A, an application program 202 (such as, but not limited to, an accounting application, etc.) executed by the one or more processors of merchant computing system 110 may perform operations that generate, and store within a locally accessible data repository, such as data repository 204, elements of offer data 206 that identify and characterize the offered ability to reserve the ability to initiate the future purchase transaction involving merchant 111 in accordance with one or more predetermined terms and conditions based on the approval of the initial, real-time payment of an agreed-upon amount requested by merchant 111 during a current temporal interval. By way of example, and as described herein, merchant 111 may elect to offer user 101 the opportunity to the reserve, based on an initial down payment of $1,000.00 on Sep. 1, 2022, the ability to purchase roof-replacement services in Washington, D.C., for a fixed purchase price of $12,000.00 during a subsequent, six-month temporal interval (e.g., extending through and including Mar. 1, 2023) in accordance with one or more one or more predetermined terms or conditions.

By way of example, the elements of offer data 206 may include data 208 that specifies the fixed purchase price of $12,000.00 for the roof replacement services and that identifies, among other things, total labor costs associated with the roof-replacement services, aggregated and unit costs of the associated products (e.g., the shingles, plywood sheathing, etc.), an expected subtotal cost, or any imposed local sales taxes. The elements of offer data 206 may also include, among other things, data 210 characterizing the initial down-payment of $1,000.00, and data 212 identifying the requested payment date associated with the initial down payment, e.g., Sep. 1, 2022, which establishes the ability of user 101 to initiate the purchase of the roof-replacement services from merchant 111 at any point during the future temporal interval, e.g., the six-month temporal interval identified within the elements of interval data 214 of offer data 206. Further, the elements of offer data 206 may also include one or more unique identifiers 216 of the roof-replacement services offered by merchant 111, such as, but not limited to, a service name, an alphanumeric identifier assigned to the roof-replacement services by merchant computing system 110, or a universal product code (UPC) or stock-keeping unit (SKU) of one or more products associated with the roof-replacement services.

Further, the elements of offer data 206 may also include data 218 characterizing the predetermined terms and conditions of the offered roof-replacement services. By way of example, the terms and conditions specified within data 218 may include, among other things, an expected duration of the roof-replacement services, a limitation on a scope of the roof-replacement services (e.g., a maximum roof area, one or more excluded days or weeks, etc.), or a limitation on a scope of the products associated with the roof-replacement services (e.g., identifiers, such as UPCs or SKUs, of shingles, plywood sheathing, and other products covered by the fixed purchase price of within the offered roof-replacement services). The disclosed embodiments are, however, not limited to these exemplary elements of offer data 206, and in other instances, offer data 206 may include any additional, or alternate, elements of data that identify and characterize the offered opportunity to reserve the ability to purchase the roof-replacement service for the fixed purchase price of $12,000.00 during the future, six-month period in accordance with the one or more predetermined terms or conditions.

In some instances, and based on one or more programmatic commands generated by executed application program 202, the one or more processors of merchant computing system 110 may execute a real-time payment (RTP) engine 220, and executed RTP engine 220 may access data repository 204 and obtain the elements of offer data 206, which identify and characterize the opportunity offered to user 101 to reserve the ability to purchase the roof-replacement service for the fixed purchase price of $12,000.00 during the future, six-month period in accordance with the one or more predetermined terms or conditions. Executed RTP engine 220 may obtain, from data repository 204, one or more elements of customer data 222, which identify and characterize user 101, and one or more elements of merchant data 224, which identify and characterize merchant 111.

As described herein, the elements of customer data 222 may include the unique customer identifier associated with user 101 (e.g., the alphanumeric character string assigned to user 101 by merchant computing system 110, etc.), the full name of user 101 (e.g., “John Q. Smith”), and/or the postal address of user 101 (“2220 Eye Street N.W., Washington, D.C., 20037 US”). The elements of customer data 222 may also identify a payment instrument held by user 101 and available to fund the initial down payment of $1,000.00 requested from user 101 by merchant 111. The payment instrument may be issued by the financial institution associated with FI computing system 130, examples of the payment instrument may include, but are not limited to, a loan product (e.g., an installment loan), a credit card account issued by the financial institution, a secured or unsecured credit product issued by the financial institution (e.g., an unsecured or secured line-of-credit, an unsecured personal loan, etc.), or a checking, savings, or other deposit account issued by and maintained at the financial institution. By way of example, the elements of customer data 222 may include all or a selected portion of an account number of the payment instrument (e.g., the actual or tokenized account number) and in some instances, the expiration data and/or card verification code (e.g., associated with a credit-card account held by user 101), or the routing number (e.g., associated with a deposit account held by user 101).

In some instances, user 101 may represent an existing customer of merchant 111, and merchant computing system 110 may perform operations that obtain all, or a selected portion of, the elements of customer data 222 during an initiation, and execution, of one or more purchase transactions involving corresponding home-improvement services, such as, but not limited to, a previous purchase of window-replacement services during a prior, six-month temporal interval. In other instances, user 101 may represent a prospective customer of merchant 111, and merchant computing system 110 may perform operations that obtain all, or a selected portion of, the elements of customer data 222 based on a prior inquiry of user 101 regarding an availability of merchant 111 to perform roof-replacement services at the home of user 01 in Washington, D.C. Further, in other instances, the financial institution of merchant 111, such as, not limited to, the financial institution associated with FI computing system 130, may identify user 101 as a prospective customer of merchant 111, and based on an obtained permission of user 101, FI computing system 130 may perform operation that provision all, or a selected portion of, the elements of customer data 222 to merchant computing system 110, e.g., as a value-added services to merchant 111. By way of example, user 101 may also represent an existing customer of the financial institution associated with FI computing system 130, and FI computing system 130 may identify user 101 as a prospective customer of FI computing system 130 based on a recent approval, and issuance, of a home-equity line-of-credit (HELOC) to user 101 or based on an age of the home of user 101 within Washington, D.C.

Further, the one or more elements of merchant data 224 may include, but are not limited to, an identifier of merchant 111 (e.g., a merchant name, such as “Lex's Home Improvement”), a postal address associated with merchant 111 (e.g., an actual postal address, such as “6201 Arlington Boulevard, Falls Church, Va., 22044, US” etc.), and information that identifies a financial services account associated with merchant 111 and capable of receiving proceeds from one or more of the purchased transactions described herein (e.g., an account number, a routing number, etc.). As described herein, examples of the financial services account may include, but are not limited to, a checking, savings, or other deposit account issued by and maintained at the financial institution associated with FI computing system 130 (or at another, unrelated financial institution).

Executed RTP engine 220 may also obtain, from data repository 204, one or more elements of field mapping data 226. The one or more elements of field mapping data 226 may, for example, characterize a structure, composition, or format of one or more data fields of an ISO-20002-compliant RFP message, such as those described herein, and additionally, or alternatively, an RFP message compliant with another standardized data-exchange protocol. In some instances, based on portions of the elements of offer data 206, customer data 222, and merchant data 224, executed RTP engine 220 may perform any of the exemplary processes described herein to generate a request-for-payment (RFP) message 228 that is structured and formatted in accordance with the one or more elements of field mapping data 226 and that requests, from user 101 in real-time, the initial down payment of $1,000.00, which reserves the ability to purchase the roof-replacement service for the fixed purchase price of $12,000.00 during the future, six-month period in accordance with the one or more predetermined terms or conditions.

As described herein, RFP message 228 may be structured in accordance with the ISO 20022 standard for electronic data exchange between financial institutions, and in some examples, RFP message 228 may correspond to a pain.013 message, as specified within the ISO 20022 standard. Further, and as described herein, the one or more elements of field mapping data 226 may characterize a structure, composition, or format of one or more data fields of ISO-20002-compliant RFP message 228 (e.g., the one or more data fields within the pain.013 message).

By way of example, ISO-20022-compliant RFP message 228 may include among other things: (i) message fields populated with data specifying a full name and postal address of user 101; (ii) message fields populated with data identifying payment instrument selected by user 101 to fund the initial down payment; (iii) message fields populated with data specifying a name and postal address of merchant 111; (iv) message fields populated with data identifying a financial services account held by merchant 111 and available to receive processed from the requested, initial down payment; and (v) message fields populated with one or more parameter values that characterize the initial down payment of $1,000.00 and the and/or a requested payment date of Sep. 1, 2022. Further, ISO-20022-compliant RFP message 228 may also include one or more structured or unstructured message fields that specify additional information associated with the initial down payment and the future purchase transactions, the offered roof-replacement services, and the predetermined terms and conditions “locked down” by the requested, initial down payment of $1,000.00.

Examples of the additional information include, but are not limited to, information identifying the fixed purchase price of $12,000.00 (e.g., as maintained within data 208 of offer data 206), information identifying the future six-month temporal interval during which user 101 may redeem the offered roof-replacement services (e.g., a six-month “redemption” interval maintained within data 214 of offer data 206), values of one or more transaction parameters characterizing the fixed purchase price of the offered roof replacement services (e.g., labor costs associated with the offered roof replacement services, aggregate costs associated with each of the associated products, a subtotal, and an amount of imposed local taxes, etc.), and information identifying and characterizing the predetermined, and fixed, terms and conditions of the offered roof-replacement services (e.g., as maintained within data 218 of offer data 206). Additionally, or alternatively, the additional information may also include a link to elements of structured or unstructured offer data characterizing the offered opportunity to reserve the ability to purchase the roof-replacement service for the fixed purchase price of $12,000.00 during the future, six-month period in accordance with the one or more predetermined terms or conditions (e.g., a hyperlink to elements of offer data 206, or elements of offer data formatted in PDF or HTML form). In some instances, as described herein, the link may include a long-form uniform resource locator (URL) or a shortened URL, such as a tiny URL, actionable by FI computing system 130 using any of the exemplary processes described herein.

In some instances, executed RTP engine 220 may parse the elements of offer data 206, customer data 222, and merchant data 224, and may perform operations that populate the message fields of RFP message 228 with corresponding elements of offer data 206, customer data 222, and merchant data 224 in accordance with field mapping data 226. For example, executed RTP engine 220 may parse offer data 206 and obtain data that specifies a requested payment date (e.g., Sep. 1, 2022), a requested payment amount for the initial down payment (e.g., the $1,000.00 down payment maintained within data 210 purchase price), and a currency associated with that requested payment amount (e.g., U.S. dollars). Executed RTP engine 220 may also format the requested payment data, the requested payment amount, and the requested payment currency in accordance with portions of field mapping data 226. As illustrated in FIG. 2B, executed RTP engine 220 may perform operations that populate message field 230 of RFP message 228 with the formatted payment date (e.g., “2022-09-01”) and message fields 232 of RFP message 228 with respective ones of the formatted payment amount (e.g., “1,000.00”) and formatted payment current (e.g., “USD”).

Further, executed RTP engine 220 may parse the elements of customer data 222 to obtain a name of user 101 (e.g., “John Q. Stone”), a postal address associated with user 101 (e.g., “2220 Eye Street NW, Washington, D.C., 20037, US”), and information that identifies (e.g., an “identification” of) the payment instrument held by user 101 and available to fund the requested, initial down payment (e.g., the corresponding account number “XXXX-1234-5678-9012”). In some instances, executed RTP engine 220 may format the obtained customer name, the obtained customer address, and the obtained identification of the payment instrument in accordance with portions of field mapping data 226, and as illustrated in FIG. 2B, executed RTP engine 220 may perform operations that populate message fields 234 of RFP message 228 with respective portions of the formatted customer name and customer address, and that populate message field 236 with the formatted identification of the selected payment instrument.

Executed RTP engine 220 may also parse the elements of merchant data 224 to obtain a name of merchant 111 (e.g., “Lex's Home Improvement”), a postal address associated with merchant 111 (e.g., “6201 Arlington Boulevard, Falls Church, Va., 22044, US”), and an identifier of a financial services account associated with merchant 111 and capable of receiving proceeds from the initial down payment (e.g., the account number “XXXX-9012-3456-7890”). In some instances, executed RTP engine 220 may format the obtained merchant name, the obtained merchant address, and the obtained identifier of the merchant account in accordance with portions of field mapping data 226, and as illustrated in FIG. 2B, executed RTP engine 220 may perform operations that populate message fields 238 of RFP message 228 with respective portions of the formatted merchant name and merchant address, and that populate message field 240 with the formatted identification of the merchant account.

Further, and as described herein, RFP message 228 may also include one or more message fields, such as message field 242, that specify offer information associated with the offered opportunity to reserve the ability to purchase the roof-replacement service for the fixed purchase price of $12,000.00 during the future, six-month period in accordance with the one or more predetermined, and fixed, terms or conditions. In some instances, not illustrated in FIG. 2A or 2B, message field 242 may correspond to an unstructured message field, and executed RTP engine 220 may populate message field 242 with one or more elements of offer data 206, which identify and characterize the future purchase of the roof replacement services, the future, six-month redemption period, and the predetermined, and fixed, terms and conditions “locked-in” by the requested, initial down payment, and one or more elements of transaction data that characterize the future purchase, such as, but not limited to, total labor costs associated with the roof-replacement services, aggregated and unit costs of the associated products (e.g., the shingles, plywood sheathing, etc.), an expected subtotal cost, or any imposed local sales taxes (e.g., as maintained within data 210 of offer data 206).

In other instances, message field 242 may include a link to offer data (e.g., a term sheet, etc.) structured in PDF or HTML format and identifying merchant 111, a postal address associated with merchant 111, and the offered opportunity to reserve the ability to purchase the roof-replacement service for the fixed purchase price of $12,000.00 during the future, six-month period in accordance with the one or more predetermined terms or conditions. For example, executed application program 202 may generate one or more elements of formatted offer data 244 that, among other things, include: an identifier of merchant 111 (e.g., the merchant name “Lex′ Home Improvement”) and a postal address associated with merchant 111 (e.g., “6201 Arlington Boulevard, Falls Church, Va., 22044, US”); one or more elements of transaction data (e.g., the fixed purchase price of $12,000.00 for the roof-replacement services, names, UPCs, and/or SKUs of the roof-replacement services and the associated products, total labor costs associated with the roof-replacement services, aggregated and unit costs of the associated products, an expected subtotal cost, or any imposed local sales taxes); information identifying the initial down payment of $1,000.00 and the available payment instrument (e.g., a tokened portion of the account number of the selected funding account, etc.); information identifying the six-month redemption period extending through Mar. 1, 2023; and one or more of the predetermined terms and conditions.

In some instances, merchant computing system 110 may perform operations that store the elements of formatted offer data 244 within a portion of data repository 204, along with corresponding elements of linking data 246 that include, among other things, a long-form or shortened URL associated with the stored elements of formatted offer data 244 (e.g., that point to the storage location of formatted offer data 244 within data repository 204). In some instances, executed RTP engine 220 may perform operations that obtain linking data 246 from data repository 204, and that process and package all, or a selected portion, of linking data 246 within a corresponding unstructured message field of RFP message 228. For example, linking data 246 may include a long-form URL (e.g., http://www.example.com/offer?custid=‘1234’?zip=22044) that points to formatted offer data 244 maintained within data repository 204 and includes the actual postal code of merchant 111 (e.g., “22044”) and the customer identifier assigned to user 101 by merchant computing system 110 (e.g., “1234”), and as illustrated in FIG. 2B, executed RTP engine 220 may parse linking data 246, obtain the long-form URL, and package the long-form URL into an unstructured message field 242 of RFP message 228. The disclosed embodiments are, however, not limited to RFP messages populated with these exemplary elements of customer, merchant, payment, transaction, and additional remittance data, and in other examples, RFP message 228 may include any additional, or alternate, message fields specified within field mapping data 226 and consistent with the ISO 20022 standard for electronic data exchange, and executed RTP engine 220 may populate these message fields with any additional, or alternate, structured and formatted elements of customer, merchant, payment, transaction, or additional offer data appropriate to RFP message 228 and field mapping data 226.

As illustrated in FIG. 2A, executed RTP engine 220 may perform operations that cause merchant computing system 110 to broadcast now-populated RFP message 228 across communications network 120 to one or more computing systems or devices within computing environment 100 that are associated with participants in the RTP ecosystem, such as, but not limited to, FI computing system 130, a computing system associated with a financial institution, or one or more computing systems associated with a real-time payment (RTP) processing network, such as a clearinghouse system. In some instances, and prior to broadcasting now-populated RFP message 228 across communications network 120, executed RTP engine 220 may perform operations that encrypt RFP message 228 using a corresponding encryption key, and examples of the corresponding encryption key include, but are not limited to, a public cryptographic key associated with FI computing system 130.

For example, merchant computing system 110 may broadcast RFP message 228 directly across communications network 120 to FI computing system 130. In other examples, merchant computing system 110 may broadcast RFP message 228 across communications network 120 to one or more intermediate computing systems, such as, but not limited to, the clearinghouse system associated with the RTP processing network. The clearinghouse system may, for example, parse RFP message 228 to access, within a corresponding one of the message fields, tokenized account data associated with the customer-specified funding account, and based on the tokenized account data, the clearinghouse system may identify the financial institution of user 101. The financial institution of user 101 may, for example, represent a participant in the RTP processing network, and the clearinghouse system may perform operations that obtain a network address associated with one or more computing systems of the financial institution of user 101 (e.g., a network address of FI computing system 130), and the clearinghouse system may route RFP message 228 across communications network 120 to FI computing system 130 based on the obtained network address.

In some instances, when executed by the one or more processors of merchant computing system 110, executed RTP engine 220 may perform any of the exemplary processes described herein to populate the structured message fields of RFP message 228 with corresponding elements of offer data 206, customer data 222, merchant data 224, and linking data 246 in accordance with field mapping data 226 (e.g., in accordance with the ISO 20002 data-exchange protocol). The disclosed embodiments are, however, not limited to the generation and population of ISO-20022-compliant RFP messages by merchant computing system 110 and in other instances, an additional, or alternate, computing system associated with the RTP processing network based on portions of the elements of offer data 206, customer data 222, merchant data 224, and linking data 246 maintained at merchant computing system 110.

By way of example, the financial institution of merchant 111 may differ from, and may be unrelated to, the financial institution associated with FI computing system 130. In some instances, merchant computing system 110 may perform operations, not illustrated in FIG. 2A, that package portions of the elements of offer data 206, customer data 222, merchant data 224, and linking data 246 into corresponding portions of an offer request, which merchant computing system 110 may transmit across communications network 120 to a computing system associated with, or operated by, a financial institution of merchant 111 (e.g., a “merchant FI computing system”). The financial institution of merchant 111, and the merchant FI computing system, may each represent participants in the RTP ecosystem, and the merchant FI computing system may receive the payment request from merchant computing system 110 and may perform operations that obtain the elements of offer data 206, customer data 222, merchant data 224, and linking data 246 from the payment request.

Based on the obtained elements of offer data 206, customer data 222, merchant data 224, and linking data 246, the merchant FI computing system (not illustrated in FIG. 2A) may perform any of the exemplary processes described herein to generate an ISO-20022-compliant request-for-payment (RFP) message, structured similarly to RFP message 228 described herein, that requests an initial, real-time down payment of $1,000.00 from the payment instrument of user 101 to reserve user 101's ability to purchase the roof-replacement service for the fixed purchase price of $12,000.00 during the future, six-month period in accordance with the one or more predetermined terms or conditions. The merchant FI computing system may also perform any of the exemplary processes described herein to broadcast the generated RFP message directly across communications network 120 to FI computing system 130, or across communications network 120 to one or more of intermediate computing systems associated with the RTP processing network, such as the clearinghouse system.

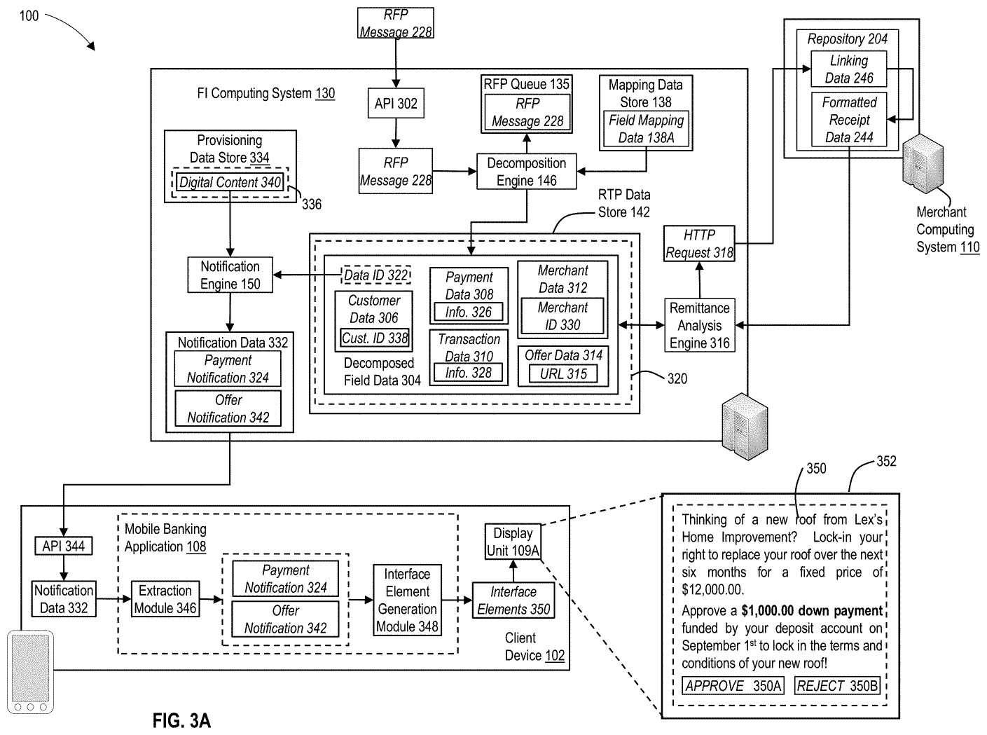

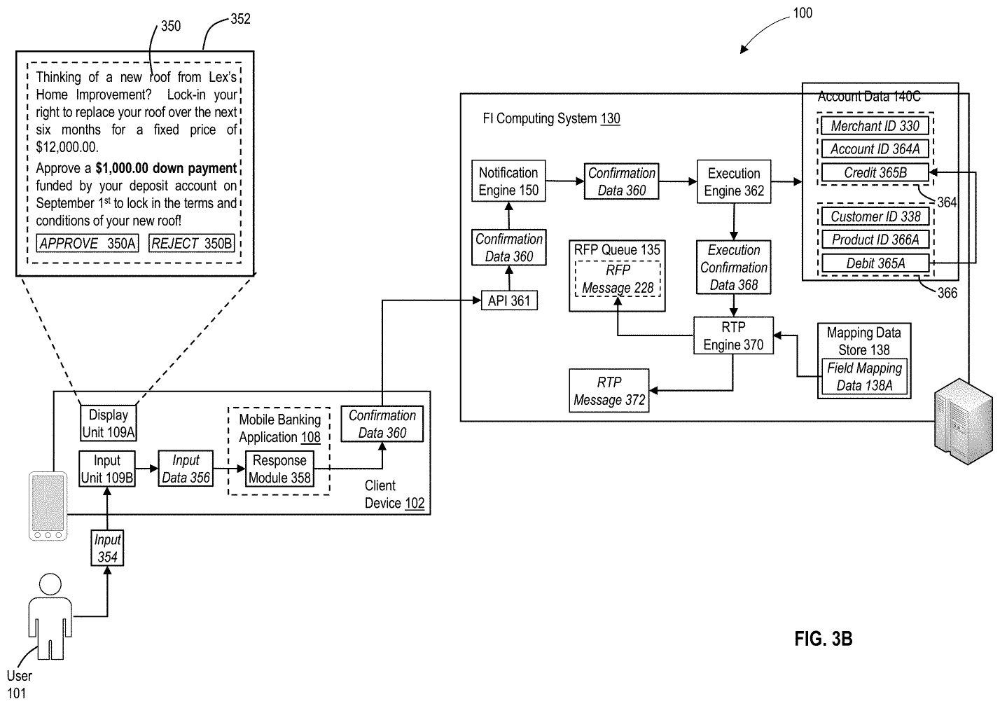

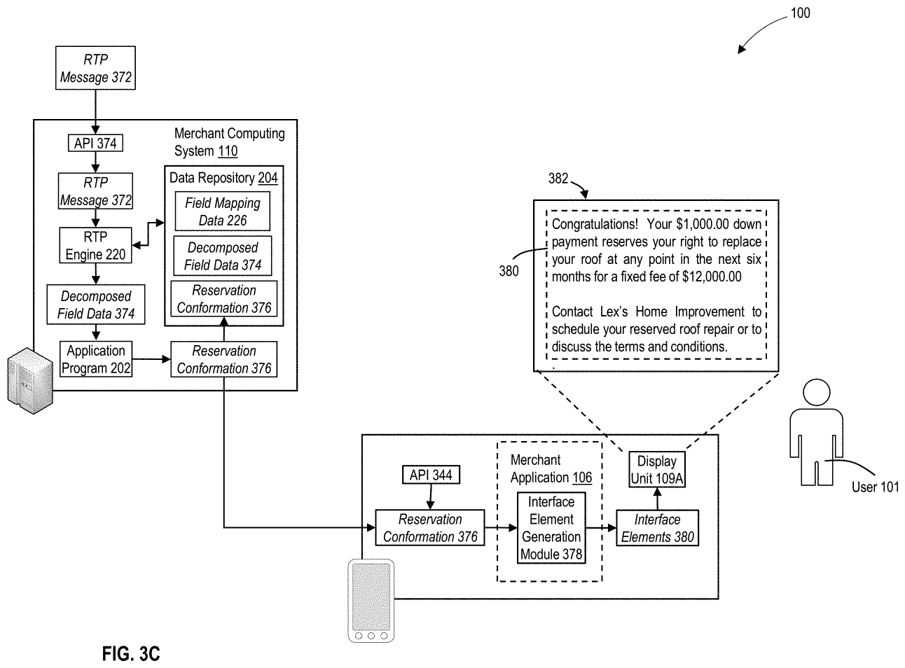

Referring to FIG. 3A, a programmatic interface established and maintained by FI computing system 130, such as application programming interface (API) 302, may receive RFP message 228, and may route RFP message 228 to decomposition engine 146, which may be executed by the one or more processors of FI computing system 130. In some examples, FI computing system 130 may receive RFP message 228 directly across communications network 120 via a channel of communications established programmatically between API 302 and executed RTP engine 220 of merchant computing system 110. In other examples, FI computing system 130 may receive RFP message 228 across communications network 120 from one or more of computing systems or devices associated with the participants in the RTP ecosystem, such as, but not limited to, the clearinghouse system described herein. Further, and as described herein, one or more portions of RFP message 228 may be encrypted (e.g., using a public cryptographic key associated with FI computing system 130), and executed decomposition engine 146 may perform operations that access a corresponding decryption key maintained within the one or more tangible, non-transitory memories of FI computing system 130 (e.g., a private cryptographic key associated with FI computing system 130), and that decrypt the encrypted portions of RFP message 228 using the corresponding decryption key.

In some instances, executed decomposition engine 146 may store RFP message 228 (in decrypted form) within a corresponding portion of data repository 134, e.g., within RFP queue 136. Executed decomposition engine 146 may also perform operations that access mapping data store 138 (e.g., as maintained within data repository 134), and obtain one or more elements of field mapping data 138A that characterize a structure, composition, or format of one or more data fields of RFP message 228. For example, and as described herein, RFP message 228 may include message fields consistent with the ISO 20022 standard for electronic data exchange between financial institutions, and each of the message fields may be populated with data structured and formatted in accordance with the ISO 20022 standard.

As described herein, RFP message 228 may be associated with a real-time payment requested from user 101 by merchant 111 on Sep. 1, 2022, as an initial down payment that reserves user 101's ability to purchase the roof-replacement service from merchant 111, for the fixed purchase price of $12,000.00 during the future, six-month period (e.g., on or before Mar. 1, 2023), and in accordance with the one or more predetermined, and fixed, terms or conditions. By way of example, RFP message 228 may include, but is not limited to, a message field populated with data specifying the requested payment date of September 1^{st} (e.g., message field 230 of FIG. 2B) and message fields populated within data specifying the requested payment amount of US $1,000.00 (e.g., message fields 232 of FIG. 2B). RFP message 228 may also include, but is not limited to, message fields populated with data that identify and characterize user 101 (e.g., message fields 234 of FIG. 2B) and merchant 111 (e.g., message fields 238 of FIG. 2B), along with additional message fields populated with data that identify the payment instrument held by user 101 and available to fund the requested, real-time payment (e.g., message field 236 of FIG. 2B) and the financial services account associated with merchant 111 and capable of receiving proceeds from the purchase transaction (e.g., message field 240 of FIG. 2B).

Further, and as described herein, RFP message 228 may include one or more additional data fields populated with structured or unstructured offer data, such as, but not limited to, a long-form URL that points to formatted offer data 244 maintained within data repository 204 of merchant computing system 110 (e.g., message field 242 of FIG. 2B, which may include http://www.example.com/offer?custid=‘1234’?zip=‘22044’). The disclosed embodiments are, however, not limited to structured or unstructured remittance data that includes a long-form URL, and in other instances, the structured or unstructured offer data may include a shortened URL that points to formatted offer data 244 and additionally, or alternatively, one or more of the elements of offer data 206 maintained within data repository 204 by merchant computing system 110, which identify and characterize the future purchase of the roof replacement services, the future, six-month redemption period, and the predetermined terms and conditions “locked-in” by the requested, initial down payment, and one or more elements of transaction data that characterize the future purchase, as described herein.

Based on the obtained elements of field mapping data 138A, executed decomposition engine 146 may perform operations that parse RFP message 228 and obtain elements of decomposed field data 304 that identify and characterize user 101, merchant 111, and the requested, $1,000.00 down payment that reserves user 101's ability to purchase the roof-replacement service from merchant 111, for the fixed purchase price of $12,000.00 during the future, six-month period, and in accordance with the one or more predetermined terms or conditions. In some instances, and through the performance of these exemplary operations, executed decomposition engine 146 may “decompose” the structured or unstructured data populating the message fields of RFP message 228 in accordance with field mapping data 138A, and generate the elements of decomposed field data 304 that include, but is not limited to, elements of customer data 306, payment data 308, transaction data 310, and merchant data 312.

By way of example, and based on the elements of field mapping data 138A, executed decomposition engine 146 may determine that message fields 234 of RFP message 228 include data that identifies and characterizes user 101, and may perform operations that obtain, from message fields 234, a customer name of user 101 (e.g., “John Q. Stone”) and a customer address of user 101 (e.g., “2220 Eye Street NW, Washington, D.C., 20037, US”). Further, as illustrated in FIG. 3A, executed decomposition engine 146 may package the obtained customer name and address into corresponding portions of customer data 306.

Further, based on the elements of field mapping data 138A, executed decomposition engine 146 may determine that message fields 230 and 236 of RFP message 228 include data identifying respective ones of the requested payment date and the payment instrument selected by user 101 to fund the purchase transaction. In some instances, executed decomposition engine 146 may perform operations that obtain, from respective ones of message fields from message fields 240 and 246, the requested payment date of Sep. 1, 2022, and the information that identifies the selected payment instrument (e.g., the account number “XXXX-1234-5678-9012”), which executed decomposition engine 146 may package into corresponding portions of payment data 308. Executed decomposition engine 146 may also determine, based on the elements of field mapping data 138A, that message fields 232 of RFP message 228 include data identifying the requested payment amount and the currency associated with that requested payment amount. In some instances, executed RTP engine 220 may perform operations that obtain, from respective ones of message fields 242, data that identifies the $1,000.00 requested payment amount and the requested denomination in U.S. currency, and package the obtained data within corresponding portions of transaction data 310.

In some instances, and based on the elements of field mapping data 138A, executed decomposition engine 146 may determine that message field 238 includes data identifying and characterizing merchant 111, and that message field 240 includes data identifying the financial services account associated with merchant 111 and capable of receiving proceeds from the purchase transaction. Executed decomposition engine 146 may perform operations that obtain, from message fields 238, a name of merchant 111 (e.g., “Lex's Home Improvement”) and a postal address associated with merchant 111 (e.g., “6201 Arlington Boulevard, Falls Church, Va., 22044, US”), and that obtain, from message field 240, the information identifying the financial services account associated with merchant 111 (e.g., the account number “XXXX-9012-3456-7890” of the merchant account). Further, executed decomposition engine 146 may perform additional operations that package the obtained merchant name, the obtained merchant address, and the obtained information identifying the merchant account into corresponding portions of merchant data 312.

Additionally, and as described herein, executed decomposition engine 146 may also determine, based on the elements of field mapping data 138A, that message field 242 of RFP message 228 includes structured or unstructured elements of data that characterizes further the offered opportunity to reserve the ability to purchase the roof-replacement service for the fixed purchase price of $12,000.00 during the future, six-month period in accordance with the one or more predetermined terms or conditions. In some instances, not illustrated in FIG. 3A, message field 242 may be populated with one or more elements of structured or instructed offer data, which identify and characterize the future purchase of the roof replacement services, the future, six-month redemption period, and the predetermined terms and conditions “locked-in” by the requested, initial down payment, and one or more elements of structured or unstructured transaction data that characterize the future purchase, such as, but not limited to, total labor costs associated with the roof-replacement services, aggregated and unit costs of the associated products (e.g., the shingles, plywood sheathing, etc.), an expected subtotal cost, or any imposed local sales taxes (e.g., as maintained within offer data 206 of FIG. 2A). Executed decomposition engine 146 may obtain the structured or unstructured elements of offer and transaction data from message field 242 and package the obtained elements of remittance data into corresponding portions of offer data 314. Executed decomposition engine 146 may also perform operations that package the structured or unstructured elements of transaction data into portions of transaction data 310.

In other instances, illustrated in FIG. 3A, message field 242 may include link to offer data (e.g., a term sheet, etc.) structured in PDF or HTML format and identifying merchant 111 and the offered opportunity to reserve the ability to purchase the roof-replacement service for the fixed purchase price of $12,000.00 during the future, six-month period in accordance with the one or more predetermined terms or conditions. For example, the elements of structured or unstructured remittance data may include the long-form URL that points to formatted offer data 244 maintained within data repository 204 of merchant computing system 110, which includes, among other things, an identifier and postal address of merchant 111 and information identifying and characterizing the offered opportunity to reserve the ability to purchase the roof-replacement service for the fixed purchase price of $12,000.00 during the future, six-month period in accordance with the one or more predetermined terms or conditions, such as the exemplary elements of offer data 206 described herein. As illustrated in FIG. 3A, executed decomposition engine 146 may obtain the long-form URL from message field 242 of RFP message 228, and package that long-form URL into offer data 314, e.g., as URL 315.

The disclosed embodiments are not, however, limited to elements of structured or unstructured offer data that include a long-form URL pointing to formatted offer data maintained within data repository 204 of merchant computing system 110. In other instances, the structured or unstructured remittance data maintained within message field 242 of RFP message 228 (or within additional, or alternate, message fields of RFP message 228) may include an additional, or alternate, long-form URL pointing to formatted offer data, or unstructured or unformatted elements of offer data, maintained at merchant computing system 110 or at other computing systems within computing environment 100, a shortened URL (e.g., a tiny URL) actionable by FI computing system 130 and pointing to formatted offer data maintained at merchant computing system 110 or at other computing systems within computing environment 100, or other elements of data that identify or characterize the offered opportunity to reserve the ability to purchase the roof-replacement service for the fixed purchase price of $12,000.00 during the future, six-month period in accordance with the one or more predetermined terms or conditions, such as the exemplary elements of offer data 206 described herein.

In some instances, the one or more processors of FI computing system 130 may execute an offer analysis engine 316, which may perform operations that, based on long-form URL 315 (or the shortened URL) maintained within offer data 314 of decomposed field data 304, programmatically access elements of formatted offer data 244 maintained at merchant computing system 110, and that process the accessed elements of formatted offer data 244 to obtain additional, or alternate, elements of customer data 306, payment data 308, transaction data 310, merchant data 312, or offer data 314. For example, offer analysis engine 316 may access long-form URL 315 maintained within offer data 314, and may process long-form URL 315 and generate a corresponding HTTP request 318 for the elements of formatted offer data 244 maintained at merchant computing system 110. Executed offer analysis engine 316 may also perform operations that cause FI computing system 130 to transmit HTTP request 318 across communications network 120 to merchant computing system 110.

Merchant computing system 110 may, for example, receive HTTP request 318, and based on portions of HTTP request 318 and linking data 246 (e.g., based on a determined match or correspondence between the portions of HTTP request 318 and linking data 246), merchant computing system 110 may perform operations that obtain the elements of formatted offer data 244 from data repository 204, and that transmit the elements of formatted offer data 244 across communications network 120 to FI computing system 130, e.g., as a response to HTTP request 318. Further, as illustrated in FIG. 3A, executed offer analysis engine 316 may receive the elements of formatted offer data 244 from merchant computing system 110, and may perform any of the exemplary processes described herein to parse the elements of formatted offer data 244 (e.g., in a received format, such as a PDF or HTML form, or in a transformed or enhanced format, etc.) and obtain, from the parsed elements of formatted offer data 244, one or more of the additional, or alternate, elements of customer data 306, payment data 308, transaction data 310, merchant data 312, or offer data 314 described herein. By way of example, executed offer analysis engine 316 may apply one or more optical character recognition (OCR) processes or optical word recognition (OWR) processes to the elements of formatted offer data 244 in PDF form to generate, or obtain, elements of textual content representative of the structured or unstructured offer or transaction data that characterizes user 101, merchant 111, the requested, initial down payment of $1,000.00, the reserved, future $12,000.00 purchase of the roof-replacement services, the six-month redemption period, or the predetermined terms and conditions (e.g., that “lock-in” the future purchase of the roof replacement services, the future, six-month redemption period, and the predetermined terms and conditions).

By way of example, executed offer analysis engine 316 may perform operations that detect a presence one or more keywords within the generated elements of textual content (e.g., “address,” “roof,” “replacement,” “shingles,” “sheathing,” “labor,” “subtotal,” “tax,” etc.), and may extract elements of the textual content associated with these keywords as corresponding ones of the additional, or alternate, elements of customer data 306, payment data 308, transaction data 310, merchant data 312, or offer data 314. In other examples, executed offer analysis engine 316 may detect a presence of the additional, or alternate, elements of customer data 306, payment data 308, transaction data 310, merchant data 312, or offer data 314 within the generated textual content based on an application of one or more adaptively trained machine learning or artificial intelligence models to portions of the textual content, and examples of these adaptively trained machine learning or artificial intelligence models includes a trained neural network process (e.g., a convolutional neural network, etc.) or a decision-tree process that ingests input datasets composed of all, or selected portions, of the textual content. The disclosed embodiments are, however, not limited to exemplary processes for detecting and extracting one or more of the additional, or alternate, elements of customer data 306, payment data 308, transaction data 310, merchant data 312, or offer data 314 from the generated textual content, and in other instances, executed offer analysis engine 316 may perform any additional, or alternate, process for identifying one or more of the additional, or alternate, elements of customer data 306, payment data 308, transaction data 310, merchant data 312, or offer data 314 within the textual content derived from the processing of the elements of formatted offer data 244 in PDF format.

Further, and as described herein, the elements of formatted offer data 244 may be structured in HTML form, and may include metadata that identify and characterize user 101 (e.g., the customer name or address described herein, etc.), merchant 111 (e.g., the merchant name or address described herein, etc.), the requested, initial down payment (e.g., the $1,000.00 payment amount, etc.), the future, $12,000.00 purchase of the roof-replacement services from merchant 111, the six-month redemption period, and the predetermined terms and conditions (e.g., including the exemplary elements of structured or unstructured offer and transaction data described herein). Executed offer analysis engine 316 may perform operations that detect one or more of the elements of metadata within the elements of formatted offer data 244, and that obtain, from the elements of metadata, additional, or alternate, elements of customer data 306, payment data 308, transaction data 310, merchant data 312, or offer data 314, as described herein. The disclosed embodiments are, however, not limited to these exemplary processes for detecting and extracting the additional, or alternate, elements of customer data 306, payment data 308, transaction data 310, merchant data 312, or offer data 314 from HTML-formatted invoice data, and in other instances, executed offer analysis engine 316 may perform any additional, or alternate, process detecting and obtaining data from the elements of formatted offer data 244 structured in HTML format, including, but not limited to, an application of one or more screen-scraping processes to portions of formatted offer data 244 structured in HTML form.

In some instances, executed decomposition engine 146 may perform operations that store decomposed field data 304, which includes the element of customer data 306, payment data 308, transaction data 310, merchant data 312, and offer data 314, within a corresponding portion of data repository 134, such as within elements 320 of RTP data store 142. Executed decomposition engine 146 may also access RFP queue 136, and determine whether RFP queue 136 includes additional RFP messages awaiting decomposition. For example, FI computing system 130 may receive additional RFP messages (not illustrated in FIG. 2A), and may store these additional RFP messages within RFP queue 136 on a continuous and ongoing basis (e.g., throughout each day). If the executed decomposition engine 146 were to determine that one or more of the additional RFP messages within RFP queue 136 await processing, executed decomposition engine 146 may obtain one of these additional RFP messages, and may perform any of the exemplary processes described herein to decompose the message fields of the obtained, additional RFP message in accordance with the elements of field mapping data 138A, to obtain corresponding elements of customer data, payment data, transaction data, merchant data, and offer data, and to package the customer data, payment data, transaction data, merchant data, and remittance information into additional, decomposed field data for storage within an additional element of RTP data store 142.

Further, executed decomposition engine 146 may obtain a unique identifier 322 of the elements of decomposed field data 304 maintained within elements 320 of RTP data store 142 and additionally, of corresponding RFP message 202A maintained within RTP data store 142, and may provide identifier 322 as an input to notification engine 150 executed by the one or more processors of FI computing system 130. For example, identifier 322 may include, but is not limited to, data pointing to a storage location of the elements of decomposed field data 304 within elements 320 of RTP data store 142 or a unique alphanumeric identifier assigned to RFP message 202A and/or decomposed field data 304 by FI computing system 130, which FI computing system 130 may maintain, within RTP data store 142, in associated with RFP message 202A and decomposed field data 304 within elements 320.

In some instances, upon execution by the one or more processors of FI computing system 130, executed notification engine 150 may perform any of the exemplary processes described herein to generate elements of notification data that identify, and characterize, the opportunity, offered to user 101, to reserve the ability to purchase the roof-replacement services for the fixed purchase price of $12,000.00 during the future, six-month redemption period in accordance with the one or more predetermined terms or conditions, and the $1,000.00 payment requested from user 101 by merchant 111 on Sep. 1, 2022 e.g., as a down payment on the fixed purchase price of the future purchase of the roof-replacement services. As described herein, when provisioned to client device 102, and when rendered for presentation within a corresponding digital interface (e.g., via display unit 109A), the elements of notification data may offer user 101 the opportunity to initiate the purchase of the roof-replacement services at the fixed purchase price of $12,000.00 during the future, six-month redemption period and in accordance with the predetermined terms and conditions, and may prompt user 101 to indicate an acceptance of the offer based on an approval of the $1,000.00 real-time payment requested from user 101 by merchant 111 as a down payment on the future purchase transaction.

Executed notification engine 150 may receive identifier 322 of the elements of decomposed field data 304, and based on identifier 322, executed notification engine 150 may access elements 320 of RTP data store 142 and obtain decomposed field data 304. As described herein, decomposed field data 304 may include one or more elements of customer data 306, payment data 308, transaction data 310, merchant data 312, and offer data 314 extracted from the structured or unstructured message fields of RFP message 228 and, as such, that identify and characterize the opportunity, offered to user 101, to reserve the ability to purchase the roof-replacement services for the fixed purchase price of $12,000.00 during the future, six-month redemption period in accordance with the one or more predetermined terms or conditions, and the $1,000.00 payment requested from user 101 by merchant 111 on Sep. 1, 2022 e.g., as a down payment on the fixed purchase price of the future purchase of the roof-replacement services.

In some instances, and based on portions of decomposed field data 304, executed notification engine 150 may perform operations that generate a payment notification 324 associated with the requested, $5,500.00 real-time payment and that package payment notification 324 into a corresponding portion of notification data 332. For example, executed notification engine 150 may parse payment data 308 to obtain payment information 326 that identifies the requested payment date of Sep. 1, 2022 (e.g., obtained from message field 230 of RFP message 228) and the payment instrument held by user 101 and available to fund the purchase transaction (e.g., the account number “XXXX-1234-5678-9012” obtained from message field 236 of RFP message 228). Executed notification engine 150 may also parse transaction data 310 to obtain transaction information 328 that identifies the payment amount of the requested, $1,000.00 real-time payment requested from user 101 as a down payment and the payment currency in US dollars (e.g., obtained from message fields 232 of RFP message 228), and may parse merchant data 312 to obtain a identifier 330 of merchant 111 (e.g., a merchant name “Lex's Home Improvement” obtained from one or message fields 238 of RFP message 228). In some examples, executed notification engine 150 may perform operations that package all, or selected portion of, each of customer identifier 338, information 326 and 328, and merchant identifier 330 into corresponding portions of payment notification 324, which may be incorporated within notification data 332.

Further, executed notification engine 150 may access, within decomposed field data 304, one or more of the elements of offer data 314 that identify and characterize the offered opportunity to reserve the ability to purchase the roof-replacement service for the fixed purchase price of $12,000.00 during the future, six-month period in accordance with the one or more predetermined terms or conditions. By way of example, the elements of offer data 314 may, among other things, identify and characterize the initial down-payment of $1,000.00 and the fixed purchase price of $12,000.00, the offered roof-replacement services offered by merchant 111 (e.g., the service name, the alphanumeric identifier assigned to the roof-replacement services by merchant computing system 110, or the UPC or SKU of one or more products associated with the roof-replacement services, etc.), and the predetermined terms and conditions imposed upon the offered roof-replacement services (e.g., the limitation on the scope of the roof-replacement services or the limitation on the scope of the products associated with the roof-replacement services, as described herein, etc.).

Further, as illustrated in FIG. 3A, executed notification engine 150 may access structured or unstructured data records of a provisioning data store 334 maintained within the one or more tangible, non-transitory memories of FI computing system 130, and may parse the structured or unstructured data records of a provisioning data store 334 and identify one or more data records, such as data record 336, that includes or references a customer identifier 338 of user 101 and/or merchant identifier 330. Data record 336 may include one or more elements of digital content 340 that, when rendered for presentation within a digital interface by client device 102, offers user 101 the opportunity to reserve the ability to purchase the roof-replacement service for the fixed purchase price of $12,000.00 during the future, six-month period, and in accordance with the one or more predetermined terms or conditions, based on the approval of the real-time payment of $1,000.00 requested by merchant 111 from user 101 as an initial down payment on the fixed, $12,000.00 purchase price. For example, digital content 340 may include elements of layout data that specifies a disposition of, or a visual characteristic of, one or more interface elements available for disposition within a digital interface generated by an application program executed by client device 102, such as, but not limited to, mobile banking application 108.

Executed notification engine 150 may obtain the one or more elements of digital content 340 from data record 336, and based on the one or more elements of digital content 340 and on the elements of offer data 314 obtained from decomposed field data 304, executed notification engine 150 may generate an offer notification 342 that, when rendered for presentation within a corresponding digital interface by client device 102 in conjunction with offer notification 342 (e.g., via display unit 109A of client device 102), prompts user 101 to accept the offer to reserve the ability to purchase the roof-replacement service for the fixed purchase price of $12,000.00 during the future, six-month period, and in accordance with the one or more predetermined terms or conditions, by providing input to client device 102 (e.g., via input unit 109B of client device 102) that approves the requested, real-time down payment of $1,000.00. In some instances, executed notification engine 150 may also perform operations that package payment notification 324 and offer notification 342 into corresponding portions of notification data 332, and that cause FI computing system 130 to transmit notification data 332 across communications network 120 to client device 102.

A programmatic interface associated with one or more application programs executed at client device 102, such as an application programming interface (API) 344 associated with mobile banking application 108, may receive notification data 332 and may perform operations that cause client device 102 to executed mobile banking application 108 (e.g., through a generation of a programmatic command, etc.). Upon execution by the one or more processors of client device 102, executed mobile banking application 108 may receive notification data 332 from API 344, and a extraction module 346 of executed mobile banking application 108 may parse notification data 332 to obtain payment notification 324 and offer notification 342, and may provide payment notification 324 and offer notification 342 as inputs to an interface element generation module 348 of executed mobile banking application 108, which may perform operations that generate and route interface elements 350 to display unit 109A.

When rendered for presentation within a corresponding notification interface 352 by display unit 109A, interface elements 350 provide a graphical representation of the offered opportunity to reserve the ability to purchase the roof-replacement service from merchant 111 (e.g., “Lex's Home Improvement”) for the fixed purchase price of $12,000.00 during the future, six-month period in accordance with the one or more predetermined terms or conditions. Further, when rendered for presentation within notification interface 352 by display unit 109A, interface elements 350 also prompts user 101 to accept, or decline, the offer to reserve the purchase the roof-replacement service for the fixed purchase price of $12,000.00 during the future, six-month period, and in accordance with the one or more predetermined terms or conditions, by providing input to client device 102 (e.g., via input unit 1096 of client device 102) that approves, or rejects the real-time down payment of $1,000.00 requested by merchant 111 on Sep. 1, 2022, e.g., by providing input to input unit 109B that selects a respective one of an “APPROVE” icon 350A and a “REJECT” icon 350B presented within notification interface 352.

In some instances, user 101 may elect to accept the offered opportunity (e.g., the offered ability to purchase the roof-replacement service for the fixed purchase price of $12,000.00 during the future, six-month period and in accordance with the one or more predetermined terms or conditions) and to approve the $1,000.00 down payment for the future purchase transaction requested by merchant 111 on Sep. 1, 2022. Referring to FIG. 3B, user 101 may provide input 354 to client device 102 (e.g., via input unit 109B) that selects “APPROVE” icon 350A, and as such, that approves the real-time down payment of $1,000.00 requested by merchant 111 on Sep. 1, 2022, to reserve the purchase the roof-replacement service for the fixed purchase price of $12,000.00 during the future, six-month period and in accordance with the one or more predetermined terms or conditions. Input unit 109B may receive input 354, and may route input data 356 indicative of the selection of “APPROVE” icon 350A by user 101, and the approval of the real-time payment requested by the financial institution, to a response module 358 of executed mobile banking application 108, which may perform operations that process input data 356 and generate one or more elements of data, e.g., confirmation data 360, that confirms the acceptance by user 101 of the offered opportunity (e.g., the offered ability to purchase the roof-replacement service for the fixed purchase price of $12,000.00 during the future, six-month period and in accordance with the one or more predetermined terms or conditions), and the approval of the $1,000.00 down payment for the future purchase transaction requested by merchant 111 on Sep. 1, 2022. Executed response module 358 may perform operations that cause client device 102 to transmit the elements of confirmation data 360 across communications network 120 to FI computing system 130.

A programmatic interface established and maintained by FI computing system 130, such as an application programming interface (API) 361 associated with executed notification engine 150, may receive the elements of confirmation data 360 and may route the elements of confirmation data 360 to executed notification engine 150, which may store the elements of confirmation data 360 within the one or more tangible, non-transitory memories of FI computing system 130, e.g., within a portion of data repository 134. Executed notification engine 150 may also provide the elements of confirmation data 360 as input to an execution engine 362 that, when executed by the one or more processors of FI computing system 130, may perform operations that debit the approved $1,000.00 down payment from the payment instrument held by user 101 and in some instances, credits the $1,000.00 in proceeds to the financial services account of merchant 111.

By way of example, if the financial institution associated with FI computing system 130 were to issue both the payment instrument held by user 101 and the financial services account held of merchant 111, executed execution engine 362 may perform operations that access data records 364 of account data 140B that include, or reference merchant identifier 330 and an account identifier 364A of the financial services account of merchant 111 (e.g., tokenized account number “XXXX-9012-3456-7890”), and may access data records 366 of account data 140B that include, or reference customer identifier 338 and an account identifier 366A of the payment instrument held by user 101 (e.g., tokenized account number “XXXX-9012-3456-7890”). Executed execution engine 362 may perform operations that augment, or modify, data records 366 to include data 365A debiting the approved $1,000.00 down payment from the account of the payment instrument, and that augment, or modify, data records 364 to include data 365B crediting the $1,000.00 in proceeds from the approved down payment to the financial services account of merchant 111. Alternatively, if a financial institution unrelated to the financial institution associated with FI computing system 130 were the financial services account held of merchant 111, executed execution engine 362 may perform any of the exemplary processes described herein that augment, or modify, data records 366 to include data 365A debiting the approved $1,000.00 down payment from the account of the payment instrument.

Executed execution engine 362 may also generate one or more elements of data, e.g., execution confirmation data 368, that confirm the successful execution of the now-approved, $1,000.00 down payment requested by merchant 111 from user 101 on Sep. 1, 2022, and may route the generated elements of execution confirmation data 368 to a real-time payment (RTP) engine 370 that is executable by the one or more processors of FI computing system 130. In some instances, and upon execution by the one or more processors of FI computing system 130 (e.g., based on a programmatic signal generated by execution confirmation data 368, etc.), executed RTP engine 370 may process the elements of execution confirmation data 368, and generate an additional real-time payment (RTP) message 372 that confirms the successful execution of the now-approved, $1,000.00 down payment requested by merchant 111 from user 101 on Sep. 1, 2022 (and in some instances, when the financial services account of merchant 111 is issued by a financial institution unrelated to the financial institution associated with FI computing system 130, that transfers the $1,00.00 in funds debited from the account of the payment instrument held by user 101 to the financial services account associated with merchant 111). As described herein, RTP message 372 may include discrete elements of message data characterizing user 101 and merchant 111, the payment amount of $1,000.00, the account of the payment instrument held by user 101, and the financial services account of merchant, and the elements of message data may populate one or more data fields structured or formatted in accordance with the ISO 20022 standard for electronic data exchange (e.g., as specified within field mapping data 138A, etc.).

Executed RTP engine 370 may also perform operations that cause FI computing system 130 to broadcast RTP message 372 directly across communications network 120 to one or more of intermediate computing systems associated with the RTP processing network, such as, but not limited to, the clearinghouse system associated with the RTP processing network, as described herein. In some instances, and prior to broadcasting RTP message 372 across communications network 120, executed RTP engine 370 may perform operations that encrypt RTP message 372 using a corresponding encryption key. Further, executed RTP engine 370 may also perform operations that access RFP message 228 maintained within RFP queue 136, and delete RFP message 228 from RFP queue 136, e.g., based on the provisioning of the installment loan to user 101 and on the founding of the $5,500.00 real-time payment requested by merchant 111 using funds from the provisioned installment loan.

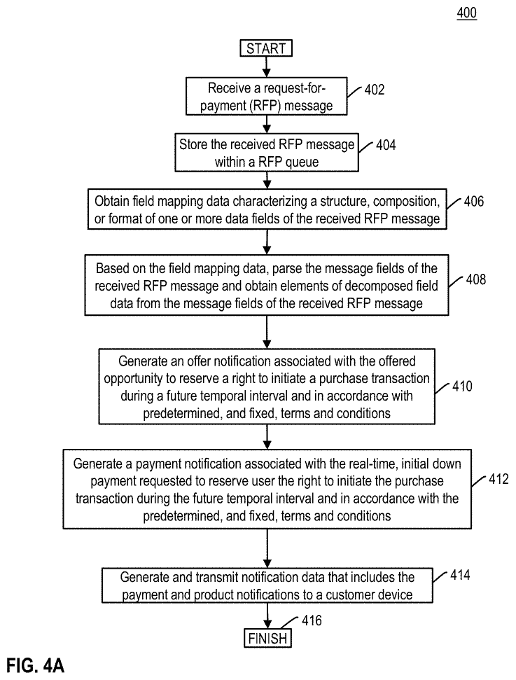

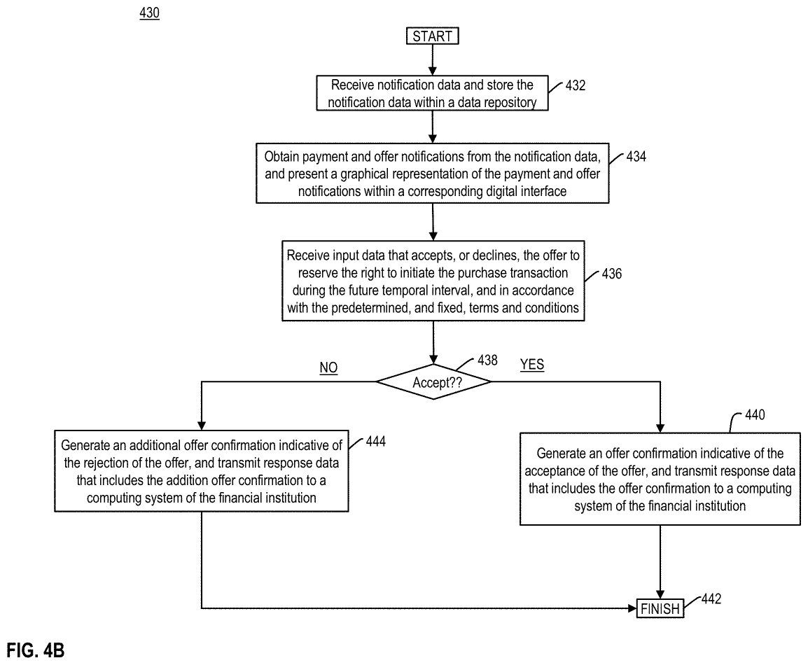

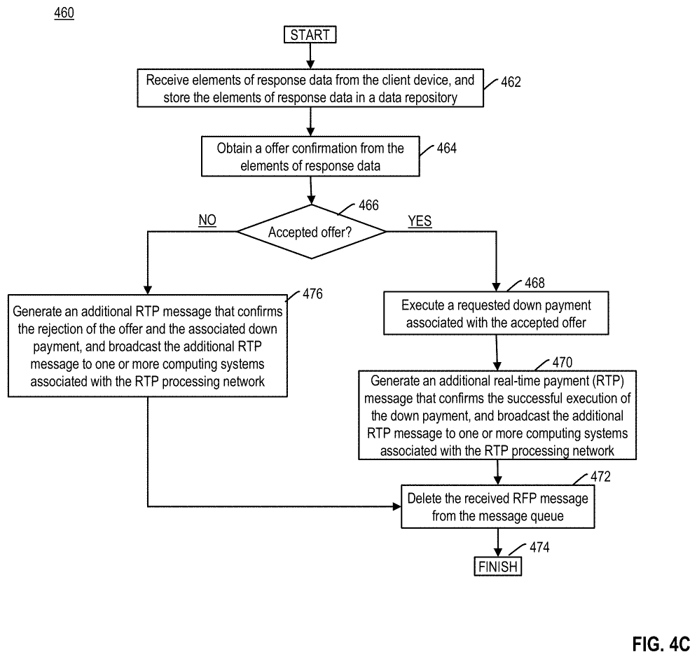

Although not illustrated in FIG. 4B, the clearinghouse system may receive RTP message 372, and the clearinghouse system may, for example, parse RTP message 372 to access, within a corresponding one of the message fields, tokenized account data associated with the financial merchant account associated with merchant 111, and based on the tokenized account data. If some instances, if the financial institution associated with FI computing system 130 were to issue both the payment instrument held by user 101 and the financial services account held of merchant 111, the clearinghouse system may perform operations that route RTP message 372 across network 120 directly to merchant computing system.

Alternatively, if a financial institution unrelated to the financial institution associated with FI computing system 130 were the financial services account held of merchant 111, the clearinghouse system may perform operations that obtain a network address associated with a computing system of the financial institution of merchant 111 (e.g., a “merchant FI computing system”), and the clearinghouse system may route RTP message 372 across communications network 120 to the merchant FI computing system based on the obtained network address. In some instances, the merchant FI computing system may receive RTP message 372, and based on the data populating the message fields of RTP message 372, the merchant FI computing system may perform operations that credit the financial services account of merchant 111 with the $1,000.00 down payment requested from user 101 by merchant 111, e.g., to reserve the ability to purchase the roof-replacement service for the fixed purchase price of $12,000.00 during the future, six-month period and in accordance with the one or more predetermined terms or condition. The merchant FI computing system may also perform operations that route RTP message 372 across communications network 120 to merchant computing system 110, e.g., as a message confirming an execution of the requested, real-time payment using funds from the provisioned installment loan (not illustrated in FIG. 4B). Further, and as described herein, one or more portions of RTP message 372 may be encrypted (e.g., using an encryption key, as described herein), and the merchant FI computing system may perform operations that access a corresponding decryption key maintained within one or more tangible, non-transitory memories, and that decrypt the encrypted portions of RTP message 372 using the corresponding decryption key.

Referring to FIG. 3C, a programmatic interface established and maintained by merchant computing system 110, such as an application programming interface (API) 450 associated with executed RTP engine 220, may receive RTP message 372 (e.g., across communications network 120 from FI computing system 130, either directly or indirectly via the clearinghouse system or the merchant FI computing system) and route RTP message 372 to executed RTP engine 220. In some instances, one or more portions of RTP message 372 may be encrypted (e.g., using an encryption key, as described herein), and the merchant FI computing system may perform operations that access a corresponding decryption key maintained within one or more tangible, non-transitory memories, and that decrypt the encrypted portions of RTP message 372 using the corresponding decryption key.

Executed RTP engine 220 may, for example, perform operations that access field mapping data 226 maintained within data repository 204, and based on the obtained elements of field mapping data 226, executed RTP engine 220 may perform operations that parse RTP message 372 and obtain elements of decomposed field data 374 that confirm a successful execution of the $1,000.00 down payment requested from user 101 by merchant 111, e.g., to reserve the ability to purchase the roof-replacement service for the fixed purchase price of $12,000.00 during the future, six-month period and in accordance with the one or more predetermined terms or conditions. Executed RTP engine 220 may store the elements of decomposed field data 374 within a portion of the one or more tangible, non-transitory memories of merchant computing system 110 (e.g., within a portion of data repository 204), and provide decomposed field data 374 as an input to executed application program 202, which may perform operations that generate elements of data, e.g., a reservation confirmation 376, that confirm the reservation, on Sep. 1, 2022, of user 101's ability to purchase the roof-replacement service from merchant 111 for the fixed purchase price of $12,000.00 during the future, six-month period ending Mar. 1, 2023, and in accordance with the one or more predetermined terms or conditions. Executed application program 202 may store reservation confirmation 376 within a portion of the one or more tangible, non-transitory memories of merchant computing system 110 (e.g., within a portion of data repository 204), and may perform operations that cause merchant computing system 110 to transmit all, or a selected portion, of the elements of reservation confirmation 376 across network 120 to client device 102.

A programmatic interface associated with one or more application programs executed at client device 102, such as an application programming interface (API) 375 associated with merchant application 106, may receive reservation confirmation 376 and may route reservation confirmation 376 to merchant application 106, which may be executed by the one or more processors of client device 102. As illustrated in FIG. 3C, an interface element generation module 378 of executed merchant application 106 may receive and process reservation confirmation 376, and may perform operations that generate and route interface elements 380 to display unit 109A. When rendered for presentation within a corresponding notification interface 382 by display unit 109A, interface elements 380 may provide a graphical representation of the confirmed reservation, on Sep. 1, 2022, of user 101's ability to purchase the roof-replacement service from merchant 111 for the fixed purchase price of $12,000.00 during the future, six-month period ending Mar. 1, 2023, and in accordance with the one or more predetermined terms or conditions, and may prompt user 101 to contact merchant 111 to schedule to roof-replacement services.

FIGS. 4A, 4B, and 4C are flowcharts of exemplary processes for provisioning, in real-time, targeted digital associated with future data exchanges to customer devices based on structured messaging data, in accordance with some exemplary embodiments. For example, one or more computing systems associated with a financial institution, such as FI computing system 130, may perform one or more of the steps of exemplary process 400, as described below in reference to FIG. 4A, and one or more of the steps of exemplary process 460, as described below in reference to FIG. 4C. Further, a computing device associated with, or operable by, user 101, such as client device 102, may perform one or more of the steps of exemplary process 430, as described below in reference to FIG. 4B.

Referring to FIG. 4A, FI computing system 130 may receive a RFP message, such as, but not limited to, RFP message 228 described herein, having message fields structured in accordance with the ISO 20022 standard (e.g., in step 402 of FIG. 4A), and may store the received RFP message within a message queue (e.g., in step 404 of FIG. 4A). In some instances, FI computing system 130 may maintain the received RFP message within the message queue until the customer provides input accepting or rejecting the requested monthly payment, or alternatively, until an expiration of a corresponding period of temporal validity. As described herein, the received RFP message may be associated with a real-time payment requested from a first counterparty (e.g., a customer of merchant, such as user 101 associated with client device 102) by a second counterparty (e.g., the merchant, such as merchant 111 associated with merchant computing system 110) during a first temporal interval, and may characterize an exchange of data, such as a purchase transaction, involving the first and second counterparties during a second temporal interval disposed subsequent to the first temporal interval.

By way of example, and to address temporal fluctuations in business activity due to factors such as seasonality, weather, or market conditions, merchant 111 may elect to offer user 101, during a current temporal interval, an ability to initiate a future purchase transaction involving merchant 111 in accordance with one or more predetermined terms and conditions based on an approval of an initial, real-time payment of an agreed-upon amount (e.g., a “down payment”) requested by merchant 111 from user 101 during the current temporal interval. In some instances, described herein, the received RFP message may be associated with the initial, real-time payment requested from user 101 by merchant 111 during the current temporal interval, an approval of which may “lock-down” an ability of user 101 to initiate the purchase transaction during the future temporal interval and in accordance with the predetermined, and fixed, terms and conditions, such as, but not limited to, a fixed purchase price.

Referring back to FIG. 4A, and responsive to the receipt of the RFP message, FI computing system 130 may access mapping data that identifies and characterizes each of the message fields within the ISO-20022-compliant RFP message (e.g., in step 406 of FIG. 4A). Based on the mapping data, FI computing system 130 may perform any of the exemplary processes described herein to parse and analyze all or a selected subset of the message fields of the RFP message to extract, obtain, or derive discrete elements of data that identify and characterize user 101, merchant 111, the requested, real-time down payment, and the offered reservation of an ability to initiate the purchase transaction during the future temporal interval and in accordance with the predetermined, and fixed, terms and conditions. (e.g., in step 408 of FIG. 4A). FI computing system 130 may perform additional operations, described herein, that store the extracted, obtained, or derived data elements of decomposed field data (e.g., that identify and characterize user 101, merchant 111, the initiated purchase transaction, the requested, real-time payment, and the offer) within an accessible data repository, e.g., within an element of RTP data store 142. For example, and as described herein, the discrete elements of data may characterize an offer, to user 101, to reserve an ability to initiate a purchase of a roof-replacement service from merchant 111 for a fixed, $12,000.00 purchase price during a future, six-month period (e.g., in accordance with the one or more predetermined terms or conditions) based on an approval of a real-time $1,000.00 down payment requested from user 101 by merchant 111 on Sep. 1, 2022.

In other instances, also in step 408, FI computing system 130 may perform any to the exemplary processes described herein to detect, within one or more of the message fields, a link to the remittance data associated with the requested monthly payment (e.g., a link to a PDF or HTML invoice or receipt that includes any of the information described herein). By way of example, the link may correspond to a long-form uniform resource locator (URL) into which certain elements of data may be embedded, such as, but not limited to, a unique identifier of the customer, and FI computing system 130 may perform operations, described herein, that parse the long URL to identify and extract the embedded data.

Additionally, or alternatively, FI computing system 130 may perform any of the exemplary processes described herein that, based on the detected link (e.g., the long-form URL described above, or a shortened URL, such as a tiny URL), programmatically access the offer data associated with the processed link, e.g., as maintained at merchant computing system 110. The offer data may include elements of offer data formatted in PDF or HTML, such as term sheet (e.g., formatted offer data 244), and the FI computing system may perform operations that process the offer data (e.g., through an application of an optical character recognition (OCR) process to the offer data structured in PDF form, parsing code associated with the HTML-based offer data, applying a screen-scraping technology to the offer data) to extract the additional or alternate elements of the data that identifies and characterizes user 101, merchant 111, the requested, real-time down payment, and the offered opportunity to reserve an ability to initiate the purchase transaction during the future temporal interval and in accordance with the predetermined, and fixed, terms and conditions.

FI computing system 130 may perform any of the exemplary processes described herein to generate an offer notification associated with the offered opportunity to reserve the ability to initiate the purchase transaction during the future temporal interval and in accordance with the predetermined, and fixed, terms and conditions (e.g., in step 410 of FIG. 4), and to generate a payment notification associated with the real-time, initial down payment requested from user 101 by merchant 111 to reserve user 101's ability to initiate the purchase transaction during the future temporal interval and in accordance with the predetermined, and fixed, terms and conditions (e.g., in step 412 of FIG. 4A). FI computing system 130 may also perform any of the exemplary processes described herein to package the generated payment notification and the generated offer notification (into corresponding portions of notification data, and to transmit the notification data across communications network 120 to client device 102 (e.g., in step 414 of FIG. 4A).

In some instances, client device 102 may receive the elements of notification data, and an application program executed by the one or more processors of client device 102 (e.g., executed mobile banking application 108) may perform any of the exemplary processes described herein to present, within a corresponding digital interface, a graphical representation of the product and payment notifications that prompts user 101 to accept the offer to reserve the ability to initiate the purchase transaction during the future temporal interval, and in accordance with the predetermined, and fixed, terms and conditions, based on a provision of input to client device 102 (e.g., via input unit 109B of client device 102) that approves the requested, real-time down payment. Exemplary process 400 is then complete in step 416.

Referring to FIG. 4B, client device 102 may perform any of the exemplary processes described herein to receive the elements of notification data from FI computing system 130, and store the elements of notification data within a portion of a tangible, non-transitory memory accessible to client device 102 (e.g., in step 432 of FIG. 4B). Client device 102 may also perform any of the exemplary processes described herein to obtain the payment and offer notifications from the received elements of notification data, and generate, and render for presentation within a corresponding digital interface, a graphical representation of portions of the payment and offer notifications that prompts user 101 to accept, or alternatively, decline, the offer to reserve the ability to initiate the purchase transaction during the future temporal interval, and in accordance with the predetermined, and fixed, terms and conditions, based on a provision of additional input to client device (e.g., via input unit 109B of client device 102) that approves, or rejects the requested, real-time down payment (e.g., in step 434 of FIG. 4B). Further, client device 102 may also receive, via input unit 109B, elements of user input that accepts, or alternatively, declines, the provisioned offer to reserve the ability to initiate the purchase transaction during the future temporal interval, and in accordance with the predetermined, and fixed, terms and conditions (e.g., in step 436 of FIG. 4B).

As described herein, the user input received via input unit 109B by may indicate an approval, or alternatively, a rejection, by user 101 of the requested, real-time down payment, and based on the elements of user input, client device 102 may determine whether user 101 approved, or rejected, the requested, real-time down payment and as such, whether user 101 accepted, or declined, the offer to reserve the ability to initiate the purchase transaction during the future temporal interval, and in accordance with the predetermined, and fixed, terms and conditions (e.g., in step 438 of FIG. 4B). If, for example, client device 102 were to determine that user 101 approved the requested, real-time down payment and as such, that user 101 accepted the offer (e.g., step 438; YES), client device 102 may perform any of the exemplary processes described herein to process the elements of input data and generate a product confirmation indicative of the approval, by user 101, of the requested, real-time down payment and the acceptance, by user 101, of the offer to reserve the ability to initiate the purchase transaction during the future temporal interval, and in accordance with the predetermined, and fixed, terms and conditions (e.g., in step 440 of FIG. 4B). Client device 102 may also perform operations that transmit a response to the notification data that includes the product confirmation to FI computing system 130 (e.g., also in step 440 of FIG. 4B). Exemplary process 430 may be complete in step 442.

Alternatively, if client device 102 were to determine that user 101 rejected the requested, real-time down payment and as such, that user 101 declined the offer to reserve the ability to initiate the purchase transaction during the future temporal interval, and in accordance with the predetermined, and fixed, terms and conditions (e.g., step 438; NO), client device 102 may perform any of the exemplary processes described herein to generate an additional product confirmation indicating the rejection of both the requested, real-time down payment and the offer to reserve the ability to initiate the purchase transaction during the future temporal interval, and in accordance with the predetermined, and fixed, terms and conditions (e.g., in step 444 of FIG. 4B). Client device 102 may also perform operations that transmit a response to the notification data that includes the additional product confirmation to FI computing system 130 (e.g., also in step 444 of FIG. 4B). Exemplary process 430 may be complete in step 442.

Referring to FIG. 4C, FI computing system 130 may receive the elements of response data from client device 102, and may store the received elements of response data within one or more tangible, non-transitory memories accessible to FI computing system 130, such as in conjunction with the elements of decomposed field data within data repository 134 (e.g., in step 462 of FIG. 4C). FI computing system 130 may also perform any of the exemplary processes described herein to obtain, from the elements of response data, the product confirmation indicative of the acceptance, or alternatively, the rejection, of the requested, real-time down payment and as such, the acceptance, or alternatively, the rejection, of the offer to reserve the ability to initiate the purchase transaction during the future temporal interval, and in accordance with the predetermined, and fixed, terms and conditions (e.g., in step 464 of FIG. 4C), and to process the product confirmation and determine whether user 101 accepted, or declined, the offer (e.g., in step 466 of FIG. 4C).

If, for example, FI computing system 130 were to determine that user 101 accepted the offer to reserve the ability to initiate the purchase transaction during the future temporal interval, and in accordance with the predetermined, and fixed, terms and conditions based on the approval of the requested real-time down payment (e.g., step 466; YES), FI computing system 130 may perform any of the exemplary processes described herein to execute the now-approved down payment from an account of a payment instrument held by user 101 to a financial services account of merchant 111 (e.g., in step 468 of FIG. 4C). FI computing system 130 may perform any of the exemplary processes described herein to generate an additional real-time payment (RTP) message that confirms the successful execution of the now-approved down payment, and to broadcast the additional RTP message directly across communications network 120 to one or more computing systems associated with the RTP processing network (e.g., in step 470 of FIG. 4C). Further, FI computing system 130 may perform operations that delete the received RFP message from the message queue (e.g., in step 472 of FIG. 4C), and exemplary process 460 may then be complete in step 474.

Alternatively, if FI computing system 130 were to determine that user 101 declined the offer to reserve the ability to initiate the purchase transaction during the future temporal interval, and in accordance with the predetermined, and fixed, terms and conditions based on the rejection of the requested real-time down payment (e.g., step 466; NO), FI computing system 130 may perform any of the exemplary processes described herein to generate an additional real-time payment (RTP) message that confirms the rejection of the both the requested real-time down payment and the offer, and to broadcast the additional RTP message directly across communications network 120 to one or more computing systems associated with the RTP processing network (e.g., in step 476 of FIG. 4C). Exemplary process 460 may pass back step 472, and FI computing system 130 may perform operations that delete the received RFP message from the message queue (e.g., in step 472 of FIG. 4C). Exemplary process 460 may then be complete in step 474.

### C. Exemplary Hardware and Software Implementations

Embodiments of the subject matter and the functional operations described in this disclosure can be implemented in digital electronic circuitry, in tangibly-embodied computer software or firmware, in computer hardware, including the structures disclosed in this specification and their structural equivalents, or in combinations of one or more of them. Embodiments of the subject matter described in this disclosure, including merchant application 106, mobile banking application 108, decomposition engine 146, notification engine 150, application program 202, real-time payment (RTP) engine 220, application programming interfaces (APIs) 302, 344, 361, and 374, remittance analysis engine 316, extraction module 346, interface element generation module 348, response module 358 execution engine 362, RTP engine 370, and interface element generation module 378, may be implemented as one or more computer programs, i.e., one or more modules of computer program instructions encoded on a tangible non-transitory program carrier for execution by, or to control the operation of, a data processing apparatus (or a computing system). Additionally, or alternatively, the program instructions can be encoded on an artificially-generated propagated signal, such as a machine-generated electrical, optical, or electromagnetic signal that is generated to encode information for transmission to suitable receiver apparatus for execution by a data processing apparatus. The computer storage medium can be a machine-readable storage device, a machine-readable storage substrate, a random or serial access memory device, or a combination of one or more of them

The terms “apparatus,” “device,” and “system” refer to data processing hardware and encompass all kinds of apparatus, devices, and machines for processing data, including by way of example a programmable processor, a computer, or multiple processors or computers. The apparatus, device, or system can also be or further include special purpose logic circuitry, such as an FPGA (field programmable gate array) or an ASIC (application-specific integrated circuit). The apparatus, device, or system can optionally include, in addition to hardware, code that creates an execution environment for computer programs, such as code that constitutes processor firmware, a protocol stack, a database management system, an operating system, or a combination of one or more of them.

A computer program, which may also be referred to or described as a program, software, a software application, an application program, an engine, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, such as one or more scripts stored in a markup language document, in a single file dedicated to the program in question, or in multiple coordinated files, such as files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, such as an FPGA (field programmable gate array) or an ASIC (application-specific integrated circuit).

Computers suitable for the execution of a computer program include, by way of example, general or special purpose microprocessors or both, or any other kind of central processing unit. Generally, a central processing unit will receive instructions and data from a read-only memory or a random-access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, such as magnetic, magneto-optical disks, or optical disks. However, a computer need not have such devices. Moreover, a computer can be embedded in another device, such as a mobile telephone, a personal digital assistant (PDA), a mobile audio or video player, a game console, a Global Positioning System (GPS) or an assisted Global Positioning System (AGPS) receiver, or a portable storage device, such as a universal serial bus (USB) flash drive, to name just a few.

Computer-readable media suitable for storing computer program instructions and data include all forms of non-volatile memory, media and memory devices, including by way of example semiconductor memory devices, such as EPROM, EEPROM, and flash memory devices; magnetic disks, such as internal hard disks or removable disks; magneto-optical disks; and CD-ROM and DVD-ROM disks. The processor and the memory can be supplemented by, or incorporated in, special purpose logic circuitry.

To provide for interaction with a user, such as user 101, embodiments of the subject matter described in this specification can be implemented on a computer having a display device, such as a CRT (cathode ray tube) or LCD (liquid crystal display) monitor, for displaying information to the user and a keyboard and a pointing device, such as a mouse or a trackball, by which the user can provide input to the computer. Other kinds of devices can be used to provide for interaction with a user as well; for example, feedback provided to the user can be any form of sensory feedback, such as visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser.

Implementations of the subject matter described in this specification can be implemented in a computing system that includes a back-end component, such as a data server, or that includes a middleware component, such as an application server, or that includes a front-end component, such as a client computer having a graphical user interface or a Web browser through which a user can interact with an implementation of the subject matter described in this specification, or any combination of one or more such back-end, middleware, or front-end components. The components of the system can be interconnected by any form or medium of digital data communication, such as a communication network. Examples of communication networks include a local area network (LAN) and a wide area network (WAN), such as the Internet.

The computing system can include clients and servers. A client and server are generally remote from each other and typically interact through a communication network. The relationship of client and server arises by virtue of computer programs running on the respective computers and having a client-server relationship to each other. In some implementations, a server transmits data, such as an HTML page, to a user device, such as for purposes of displaying data to and receiving user input from a user interacting with the user device, which acts as a client. Data generated at the user device, such as a result of the user interaction, can be received from the user device at the server.

While this specification includes many specifics, these should not be construed as limitations on the scope of the disclosure or of what may be claimed, but rather as descriptions of features specific to particular embodiments of the disclosure. Certain features that are described in this specification in the context of separate embodiments may also be implemented in combination in a single embodiment. Conversely, various features that are described in the context of a single embodiment may also be implemented in multiple embodiments separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems may generally be integrated together in a single software product or packaged into multiple software products.

In each instance where an HTML file is mentioned, other file types or formats may be substituted. For instance, an HTML file may be replaced by an XML, JSON, plain text, or other types of files. Moreover, where a table or hash table is mentioned, other data structures (such as spreadsheets, relational databases, or structured files) may be used.

Various embodiments have been described herein with reference to the accompanying drawings. It will, however, be evident that various modifications and changes may be made thereto, and additional embodiments may be implemented, without departing from the broader scope of the disclosed embodiments as set forth in the claims that follow.

Further, unless otherwise specifically defined herein, all terms are to be given their broadest possible interpretation including meanings implied from the specification as well as meanings understood by those skilled in the art and/or as defined in dictionaries, treatises, etc. It is also noted that, as used in the specification and the appended claims, the singular forms “a,” “an,” and “the” include plural referents unless otherwise specified, and that the terms “comprises” and/or “comprising,” when used in this specification, specify the presence or addition of one or more other features, aspects, steps, operations, elements, components, and/or groups thereof. Moreover, the terms “couple,” “coupled,” “operatively coupled,” “operatively connected,” and the like should be broadly understood to refer to connecting devices or components together either mechanically, electrically, wired, wirelessly, or otherwise, such that the connection allows the pertinent devices or components to operate (e.g., communicate) with each other as intended by virtue of that relationship. In this disclosure, the use of “or” means “and/or” unless stated otherwise. Furthermore, the use of the term “including,” as well as other forms such as “includes” and “included,” is not limiting. In addition, terms such as “element” or “component” encompass both elements and components comprising one unit, and elements and components that comprise more than one subunit, unless specifically stated otherwise. Additionally, the section headings used herein are for organizational purposes only and are not to be construed as limiting the described subject matter.

The foregoing is provided for purposes of illustrating, explaining, and describing embodiments of this disclosure. Modifications and adaptations to the embodiments will be apparent to those skilled in the art and may be made without departing from the scope or spirit of the disclosure.

What is claimed is:

1. An apparatus comprising:
a communications interface;
a memory storing instructions; and
at least one processor coupled to the communications interface and to the memory, the at least one processor being configured to execute the instructions to:
receive, via the communications interface, a message associated with a real-time payment requested from a first counterparty by a second counterparty during a first temporal interval, the message comprising elements of message data disposed within corresponding message fields, the elements of message data characterizing an exchange of data involving the first and second counterparties during a second temporal interval disposed subsequent to the first temporal interval;
based on the elements of messaging data, transmit notification data to a device operable by the first counterparty via the communications interface, the notification data comprising digital content associated with the requested real-time payment and the data exchange, and the device being configured to present the digital content within a digital interface; and
based on response data generated by the device, transmit first confirmation data associated with the real-time payment to a computing system operable by the second counterparty via the communications interface, the computing system being configured to initiate the data exchange during the second temporal interval based on the first confirmation data.

2. The apparatus of claim 1, wherein the at least one processor is further configured to execute the instructions to generate the notification data based on the elements of messaging data.

3. The apparatus of claim 1, wherein the at least one processor is further configured to execute the instructions to generate the first confirmation data, the first confirmation data being indicative of an execution of the real-time payment based on the elements of messaging data.

4. The apparatus of claim 1, wherein the at least one processor is further configured to execute the instructions to perform operations that execute the real-time payment during the first temporal interval based on the response data.

5. The apparatus of claim 4, wherein the at least one processor is further configured to execute the instructions to:
receive the response data from the device via the communications interface;
determine that the response data is associated with an approval of the real-time payment by the first counterparty; and
perform operations that execute the real-time payment in accordance with the elements of messaging data based on the determination that the response data is associated with the approval of the real-time payment.

6. The apparatus of claim 5, wherein:
the notification data comprises a value of a parameter of the real-time payment; and
the at least one processor is further configured to execute the instructions to perform operations that execute the real-time payment in accordance with the parameter value based on the determination that the response data is associated with the approval of the real-time payment.

7. The apparatus of claim 1, wherein:
the notification data is associated with an offer to initiate the data exchange during the second temporal interval in accordance with a value of at least one parameter of the data exchange; and
the at least one processor is further configured to execute the instructions to:
receive response data from the first device via the communications interface;
determine that the response data is associated with an acceptance of the offer to initiate the data exchange during the second temporal interval in accordance with the at least one parameter value; and
based on the determination that the response data is associated with an acceptance of the offer, transmit the first confirmation data to the computing system via the communications interface.

8. The apparatus of claim 7, wherein the at least one processor is further configured to transmit, via the communications interface, second confirmation data indicative of the acceptance of the offer to the device, the second confirmation data comprising the at least one parameter of the data exchange.

9. The apparatus of claim 7, wherein the at least one processor is further configured to execute the instructions to:
establish that the response data is associated with an approval of the real-time payment by the first counterparty; and
when the response data is associated with the approval of the real-time payment, determine that the response data is associated with the acceptance of the offer to initiate the data exchange during the second temporal interval in accordance with the at least one parameter value.

10. The apparatus of claim 1, wherein the at least one processor is further configured to execute the instructions to:
obtain, from the memory, mapping data associated with the message fields of the message;
perform operations that obtain the elements of message data from the message fields based on the mapping data; and
store the elements of message data within the memory, the elements of message data comprising a first identifier of the first counterparty, a second identifier of the second counterparty, and a value of a parameter of at least one of the real-time payment or the data exchange.

11. The apparatus of claim 10, wherein:
the message comprises a request-for-payment message, the message fields of the request-for-payment message being structured in accordance with a standardized data-exchange protocol; and
elements of the mapping data identify corresponding ones of the elements of message data and corresponding ones of the message fields.

12. The apparatus of claim 10, wherein the at least one processor is further configured to execute the instructions to:
obtain, based on the mapping data, offer information associated with the data exchange from one or more of the message fields, the offer information comprising a uniform resource locator associated with elements of formatted data maintained by a computing system associated with the second counterparty;
process the elements of formatted data; and
obtain at least one of the first identifier, the second identifier, or the parameter value of the least one of the real-time payment or the data exchange.

13. A computer-implemented method comprising:
receiving, using at least one processor, a message associated with a real-time payment requested from a first counterparty by a second counterparty during a first temporal interval, the message comprising elements of message data disposed within corresponding message fields, the elements of message data characterizing an exchange of data involving the first and second counterparties during a second temporal interval disposed subsequent to the first temporal interval;
based on the elements of messaging data, transmitting, using the at least one processor, notification data to a device operable by the first counterparty, the notification data comprising digital content associated with the requested real-time payment and the data exchange, and the device being configured to present the digital content within a digital interface; and
based on response data generated by the device, transmitting, using the at least one processor, first confirmation data associated with the real-time payment to a computing system operable by the second counterparty, the computing system being configured to initiate the data exchange during the second temporal interval based on the first confirmation data.

14. The computer-implemented method of claim 13, further comprising:
receiving, using the at least one processor, the response data from the first device;
determining, using the at least one processor, that the response data is associated with an approval of the real-time payment by the first counterparty; and
performing operations, using the at least one processor, that execute the real-time payment in accordance with the elements of messaging data based on the determination that the response data is associated with the approval of the real-time payment.

15. The computer-implemented method of claim 14, wherein:
the notification data comprises a value of a parameter of the real-time payment; and
the computer-implemented method further comprises performing operations, using the at least one processor, that execute the real-time payment in accordance with the parameter value based on the determination that the response data is associated with the approval of the real-time payment.

16. The computer-implemented method of claim 13, wherein:
the notification data is associated with an offer to initiate the data exchange during the second temporal interval in accordance with a value of at least one parameter of the data exchange; and
the computer-implemented method further comprises:
receiving response data from the first device using the at least one processor;
determining, using the at least one processor, that the response data is associated with an acceptance of the offer to initiate the data exchange during the second temporal interval in accordance with the at least one parameter value; and
based on the determination that that the response data is associated with an acceptance of the offer, transmitting, using the at least one processor, the first confirmation data to the computing system.

17. The computer-implemented method of claim 16, further comprising:
establishing, using the at least one processor, that the response data is associated with an approval of the real-time payment by the first counterparty; and
when the response data is associated with the approval of the real-time payment, determining, using the at least one processor, that the response data is associated with an acceptance of the offer to initiate the data exchange during the second temporal interval in accordance with the at least one parameter value; and
transmitting, using the at least one processor, second confirmation data indicative of the acceptance of the offer to the device, the second confirmation data comprising the at least one parameter value.

18. The computer-implemented method of claim 13, further comprising:
obtaining, using the at least one processor, and from a data repository, mapping data associated with the message fields of the message;
performing operations, using the at least one processor, that obtain the elements of message data from the message fields based on the mapping data; and
storing the elements of message data within the data repository using the at least one processor, the elements of message data comprising a first identifier of the first counterparty, a second identifier of the second counterparty, and a value of a parameter of at least one of the real-time payment or the data exchange.

19. The computer-implemented method of claim 18, further comprising:
using the at least one processor, obtaining, based on the mapping data, offer information associated with the data exchange from one or more of the message fields, the offer information comprising a uniform resource locator associated with elements of formatted data maintained by a computing system associated with the second counterparty;
processing the elements of formatted data using the at least one processor; and
obtaining, using the at least one processor, at least one of the first identifier, the second identifier, or the parameter value of the least one of the real-time payment or the data exchange.

20. A tangible, non-transitory computer-readable medium storing instructions that, when executed by at least one processor, cause the at least one processor to perform a method, comprising:
receiving a message associated with a real-time payment requested from a first counterparty by a second counterparty during a first temporal interval, the message comprising elements of message data disposed within corresponding message fields, the elements of message data characterizing an exchange of data involving the first and second counterparties during a second temporal interval disposed subsequent to the first temporal interval;
based on the elements of messaging data, transmitting notification data to a device operable by the first counterparty, the notification data comprising digital content associated with the requested real-time payment and the data exchange, and the device being configured to present the digital content within a digital interface; and
based on response data generated by the device, transmitting first confirmation data associated with the real-time payment to a computing system operable by the second counterparty, the computing system being configured to initiate the data exchange during the second temporal interval based on the first confirmation data.
